(19) United States
(12) Patent Application Publication
(10) Pub. No.: US 2025/0030127 A1
(43) Pub. Date: Jan. 23, 2025

(54) ANODE SIDE SEALING FOR BATTERY CELLS HAVING POROUS CERAMIC LAYERS

(71) Applicant: ION STORAGE SYSTEMS, INC., Beltsville, MD (US)

(72) Inventors: Elizabeth A. SANTORI, Beltsville, MD (US); Nicholas S. HUDAK, Beltsville, MD (US); Mara A. TOLKSDORF, Beltsville, MD (US); Gregory Thomas HITZ, Beltsville, MD (US); Timothy Robert CURRIE, Beltsville, MD (US); Marissa Michelle BRADLEY, Beltsville, MD (US); Connor Jackson LEACH, Beltsville, MD (US); Diana Marie LUTZ, Beltsville, MD (US); Rahul JAY, Beltsville, MD (US); Geoffrey Stephen HOWARD, Beltsville, MD (US)

(21) Appl. No.: 18/713,067

(22) PCT Filed: Nov. 9, 2022
(86) PCT No.: PCT/US2022/079575

§ 371 Date: May 23, 2024

Related U.S. Application Data
(60) Provisional application No. 63/283,149, filed on Nov. 24, 2021.

(51) Int. Cl. H01M 50/486; H01M 4/02; H01M 4/66; H01M 50/46; H01M 50/474

(52) U.S. Cl. CPC H01M 50/486; H01M 4/661; H01M 50/46; H01M 50/474; H01M 2004/021; H01M 2004/027

(57) ABSTRACT

The present disclosure provides an anode assembly for a battery cell. The battery cell comprises a separator layer, an anode layer, an anode current collector, and a seal. The anode layer is at least partially disposed on the separator layer and has a first surface facing the separator layer, a second surface facing away from the separator layer, and an outer surface extending from the first surface to the second surface. The anode layer comprises a solid-state electrolyte (SSE) having pores. The anode current collector is coupled to the second surface of the anode layer. The seal is substantially impervious to liquid. The present disclosure also provides methods of forming an anode assembly for a battery cell.

### CROSS-REFERENCE TO RELATED APPLICATIONS

This application claims the benefit of U.S. Provisional Application No. 63/283,149, filed on Nov. 24, 2021, the disclosure of which is incorporated herein by reference in its entirety.

### FIELD OF THE INVENTION

The present invention relates to an anode assembly for a battery cell and methods of forming the same.

### BACKGROUND

Solid-state batteries generally include one or more battery cells including a cathode current collector, a cathode layer, a solid-state electrolyte separator, an anode layer, and an anode current collector. Battery cells may further include a liquid catholyte on the cathode-side. The liquid catholyte promotes liquid-solid contact and provides an improved interface for ion transfer, thereby improving ionic conductivity and decreasing impedance of the battery cell. Liquid catholytes may be advantageous over gel and/or solid catholytes because liquid catholytes allow for a single electrolyte fill step during fabrication of the battery cell and allow for cell design flexibility for varying application conditions such as high energy density, improved safety, or wide temperature range operation. However, liquid catholyte leakage into the anode side (e.g., the anode layer) of the battery cell is undesirable and represents a possible failure mode of solid-state batteries that include a liquid catholyte.

As such, there remains a need to provide an improved anode assembly for a battery cell.

### SUMMARY OF THE INVENTION

In one aspect, the present invention provides an anode assembly for a battery cell. The battery cell comprises a separator layer, an anode layer, an anode current collector, and a seal. The anode layer is at least partially disposed on the separator layer and has a first surface facing the separator layer, a second surface facing away from the separator layer, and an outer surface extending from the first surface to the second surface. The anode layer comprises a solid-state electrolyte (SSE) having pores. The anode current collector is coupled to the second surface of the anode layer. The seal is at least partially disposed on the outer surface of the anode layer and comprises a sealant material. The seal is substantially impervious to liquid.

In some embodiments, the separator layer is substantially free of pores. In some embodiments, the separator layer comprises a SSE material. And, in some embodiments, the SSE material of the separator layer comprises a polymer, a sulfide, an oxide, a chalcogenide, or any combination thereof.

In some embodiments, the separator layer defines a recess and the seal is disposed in the recess.

In some embodiments, the separator layer has a thickness of from about 1 μm to about 300 μm. In some embodiments, the separator layer has a thickness of from about 1 μm to about 200 μm. In other embodiments, the separator layer has a thickness of from about 1 μm to about 100 μm. In some embodiments, the separator layer has a thickness of from about 1 μm to about 50 μm. In some embodiments, the separator layer has a thickness of from about 1 μm to about 20 μm. And, in some embodiments, the separator layer has a thickness of from about 1 μm to about 10 μm.

In some embodiments, the anode assembly further comprises an anode material disposed in at least a portion of the pores of the anode layer. In some embodiments, the anode material comprises lithium metal, sodium metal, magnesium metal, or any combination thereof. In other embodiments, the pores of the anode layer are substantially free of a metal material (e.g., lithium metal).

In some embodiments, the anode layer defines a first porous region and a second porous region. The first porous region is defined between a center and the outer surface of the anode layer. The second porous region is defined between the first porous region and the outer surface of the anode layer.

In some embodiments, the pores of the first porous region are substantially free of the sealant material. In some embodiments, at least a portion of the pores of the second porous region comprise the sealant material. And, in some embodiments, the seal is at least partially disposed on the outer surface of the anode layer and in the pores of the second porous region.

In some embodiments, the anode layer has a thickness of from about 1 μm to about 500 μm. In some embodiments, the anode layer has a thickness of from about 1 μm to about 200 μm. In other embodiments, the anode layer has a thickness of from about 1 μm to about 100 μm. In some embodiments, the anode layer has a thickness of from about 1 μm to about 50 μm. And, in some embodiments, the anode layer has a thickness of from about 1 μm to about 20 μm.

In some embodiments, the anode current collector comprises a metal foil. In other embodiments, the metal foil comprises copper, nickel, titanium, stainless steel, alloys thereof, or any combination thereof. And, in some embodiments, the metal foil has a tab configured to connect with an external circuit.

In some embodiments, the seal is at least partially disposed on the separator layer. In some embodiments, the seal is at least partially disposed on the anode current collector.

In some embodiments, the separator layer has a front surface facing the anode layer, a back surface facing away from the anode layer, and an outer surface extending from the front surface to the back surface. In other embodiments, the anode current collector has an interior surface facing the anode layer, an exterior surface facing away from the anode layer, and an outer surface extending from the interior surface to the exterior surface.

In some embodiments, the seal is at least partially disposed on the outer surface of the separator layer. In other embodiments, the seal is disposed on substantially all of the outer surface of the separator layer. In some embodiments, the seal is at least partially disposed on the back surface of the separator layer. In some embodiments, the seal is at least partially disposed on the front surface of the separator layer.

In some embodiments, the seal is at least partially disposed on the outer surface of the anode current collector. In other embodiments, the seal is disposed on substantially all of the outer surface of the anode current collector. In some embodiments, the seal is at least partially disposed on the exterior surface of the anode current collector. In other embodiments, the seal is disposed on substantially all of the exterior surface of the anode current collector. In some embodiments, the seal is at least partially disposed on the interior surface of the anode current collector. And, in some embodiments, the seal is at least partially disposed on each of the outer surface of the anode layer, the outer surface of the separator layer, and the outer surface of the anode current collector.

In some embodiments, the sealant material comprises a non-conductive polymer, a non-conductive glass, or any combination thereof. And, in some embodiments, the sealant material comprises polypropylene, polyethylene, polymethylpentene, poly butene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof.

In some embodiments, the anode assembly further comprises a housing having a plurality of interior walls defining an interior. The separator layer, the anode layer, the anode current collector, and the seal are disposed in the interior of the housing. In some embodiments, the seal extends from the outer surface of the anode layer to at least one of the plurality of interior walls of the housing.

In some embodiments, the housing further comprises a first protrusion and a second protrusion extending from at least one of the plurality of interior walls to the interior of the housing. The first and second protrusions define a cavity. The seal extends from the outer surface of the anode layer into the cavity.

In some embodiments, at least a portion of the seal has a thickness of from about 1 μm to about 50 μm. In some embodiments, at least a portion of the seal has a thickness of from about 1 μm to about 20 μm. In other embodiments, at least a portion of the seal has a thickness of from about 1 μm to about 10 μm. And, in some embodiments, at least a portion of the seal has a thickness of from about 1 μm to about 5 μm.

In some embodiments, the seal is pervious to gas.

In another aspect, the present invention provides a multi-layer anode assembly. The multi-layer anode assembly comprises a first separator layer, a second separator layer, a first anode layer, a second anode layer, an anode current collector, and a seal. The second separator layer is spaced from the first separator layer. The first anode layer is at least partially disposed on the first separator layer. The first anode layer has a first surface facing the first separator layer, a second surface facing away from the first separator layer, and an outer surface extending from the first surface to the second surface. The first anode layer comprises a SSE having pores. The second anode layer is at least partially disposed on the second separator layer. The second anode layer has a first surface facing the second separator layer, a second surface facing away from the second separator layer, and an outer surface extending from the first surface to the second surface. The second anode layer comprises a SSE having pores. The anode current collector is coupled to the second surfaces of the first and second anode layers. The seal is at least partially disposed on the outer surfaces of the first and second anode layers. The seal comprises a sealant material. And, the seal is substantially impervious to liquid.

In another aspect, the present invention provides a battery cell. The battery cell comprises a separator layer, an anode layer, an anode current collector, a cathode layer, a cathode current collector, and a seal. The separator layer has a front surface, a back surface spaced from the front surface, and an outer surface extending from the front surface to the back surface. The anode layer is at least partially disposed on the front surface of the separator layer. The anode layer has a first surface facing the separator layer, a second surface facing away from the separator layer, and an outer surface extending from the first surface to the second surface. The anode layer comprises a SSE having pores. The anode current collector is coupled to the second surface of the anode layer. The cathode layer is at least partially disposed on the back surface of the separator layer. The cathode layer has a first surface facing the separator layer, a second surface facing away from the separator layer, and an outer surface extending from the first surface to the second surface. The cathode current collector is coupled to the second surface of the cathode layer. The seal is at least partially disposed on the outer surface of the anode layer. The seal comprises a sealant material. And, the seal is substantially impervious to liquid.

In some embodiments, the battery cell further comprises a housing having a plurality of interior walls defining an interior. The separator layer, the anode layer, the anode current collector, the cathode layer, the cathode current collector, and the seal are disposed in the interior of the housing.

In some embodiments, the anode current collector has an interior surface facing the anode layer, an exterior surface facing away from the anode layer, and an outer surface extending from the interior surface to the exterior surface. In some embodiments, the cathode current collector has an interior surface facing the cathode layer, an exterior surface facing away from the cathode layer, and an outer surface extending from the interior surface to the exterior surface.

In some embodiments, the seal is at least partially disposed on each of the outer surface of the anode layer, the outer surface of the separator layer, and the interior surfaces of the anode and cathode current collectors. In some embodiments, the cathode current collector defines an aperture configured to permit filling of the cathode layer with a catholyte.

In some embodiments, the seal is at least partially disposed on each of the outer surface of the anode layer, the outer surface of the separator layer, the interior surface of the cathode current collector, and the outer and exterior surfaces of the anode current collector. In some embodiments, the cathode current collector defines an aperture configured to permit filling of the cathode layer with a catholyte.

In some embodiments, the battery cell further comprises a catholyte disposed in the cathode layer. In some embodiments, the seal is substantially impervious to the catholyte.

In some embodiments, the sealant material comprises a non-conductive polymer, a non-conductive glass, or any combination thereof. And, in some embodiments, the sealant material comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof.

In another aspect, the present invention provides methods of forming the anode assembly described herein.

### BRIEF DESCRIPTION OF THE DRAWINGS

The figures below are provided by way of example and are not intended to limit the scope of the claimed invention.

FIG. 1A is a cross-sectional view of a first exemplary embodiment of an anode assembly for a battery cell.

FIG. 1B is a cross-sectional view of an exemplary embodiment of a multi-layer anode assembly comprising two anode assemblies of FIG. 1A, wherein the anode assemblies share a common anode current collector.

FIG. 1C is a front view of the anode assembly of FIG. 1A.

FIG. 2A is a cross-sectional view of a second exemplary embodiment of an anode assembly for a battery cell.

FIG. 2B is a close-up view of a portion of the anode assembly of FIG. 2A according to one embodiment.

FIG. 2C is a close-up view of a portion of the anode assembly of FIG. 2A according to another embodiment.

FIG. 2D is a close-up view of a portion of the anode assembly of FIG. 2A according to a further embodiment.

FIG. 2E is a close-up view of a portion of the anode assembly of FIG. 2A according to yet another embodiment.

FIG. 3A is a cross-sectional view of a third exemplary embodiment of an anode assembly for a battery cell.

FIG. 3B is a cross-sectional view of an exemplary embodiment of a multi-layer anode assembly comprising two anode assemblies of FIG. 3A, wherein the anode assemblies share a common anode current collector.

FIG. 3C is a front view of the anode assembly of FIG. 3A.

FIG. 4 is a cross-sectional view of a fourth exemplary embodiment of an anode assembly for a battery cell.

FIG. 5A is a cross-sectional view of a fifth exemplary embodiment of an anode assembly for a battery cell.

FIG. 5B is a cross-sectional view of an exemplary embodiment of a multi-layer anode assembly comprising two anode assemblies of FIG. 5A, wherein the anode assemblies share a common anode current collector and a common seal.

FIG. 5C is a front view of the anode assembly of FIG. 5A.

FIG. 6A is a cross-sectional view of a sixth exemplary embodiment of an anode assembly for a battery cell.

FIG. 6B is a cross-sectional view of an exemplary embodiment of a multi-layer anode assembly comprising two anode assemblies of FIG. 6A, wherein the anode assemblies share a common anode current collector.

FIG. 6C is a front view of the anode assembly of FIG. 6A.

FIG. 7A is a cross-sectional view of a first exemplary embodiment of a battery cell.

FIG. 7B is a front view of the battery cell of FIG. 7A.

FIG. 7C is a cross-sectional view of a second exemplary embodiment of a battery cell.

FIG. 7D is a front view of the battery cell of FIG. 7C.

FIG. 8A is a cross-sectional view of a seventh exemplary embodiment of an anode assembly for a battery cell.

FIG. 8B is a cross-sectional view of an exemplary embodiment of a multi-layer anode assembly comprising two anode assemblies of FIG. 8A, wherein the anode assemblies share a common anode current collector and a common seal.

FIG. 9A is a cross-sectional view of a third exemplary embodiment of a battery cell.

FIG. 9B is a front view of the battery cell of FIG. 9A.

FIG. 9C is a cross-sectional view of a fourth exemplary embodiment of a battery cell.

FIG. 9D is a front view of the battery cell of FIG. 9C.

FIG. 10A is a cross-sectional view of a fifth exemplary embodiment of a battery cell.

FIG. 10B is a front view of the battery cell of FIG. 10A.

FIG. 10C is a cross-sectional view of a sixth exemplary embodiment of a battery cell.

FIG. 10D is a front view of the battery cell of FIG. 10C.

FIG. 11A is a cross-sectional view of a first exemplary embodiment of an electrode pair assembly.

FIG. 11B is a cross-sectional view of a second exemplary embodiment of an electrode pair assembly.

FIG. 11C is a cross-sectional view of a third exemplary embodiment of an electrode pair assembly.

FIG. 11D is a cross-sectional view of a fourth exemplary embodiment of an electrode pair assembly.

FIG. 11E is a cross-sectional view of a fifth exemplary embodiment of an electrode pair assembly.

FIG. 12A is a cross-sectional view of a sixth exemplary embodiment of an electrode pair assembly.

FIG. 12B is a cross-sectional view of a seventh exemplary embodiment of an electrode pair assembly.

FIG. 12C is a cross-sectional view of an eighth exemplary embodiment of an electrode pair assembly.

FIG. 12D is a cross-sectional view of a ninth exemplary embodiment of an electrode pair assembly.

FIG. 13 is a cross-sectional view of a tenth exemplary embodiment of an electrode pair assembly.

FIG. 14 is a flow chart of a method of forming an anode assembly according to one implementation of the invention.

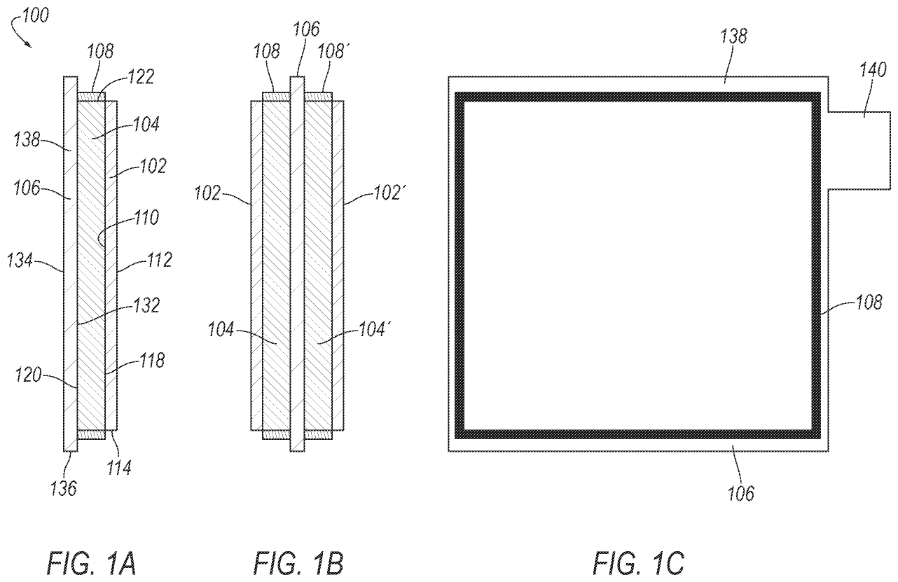

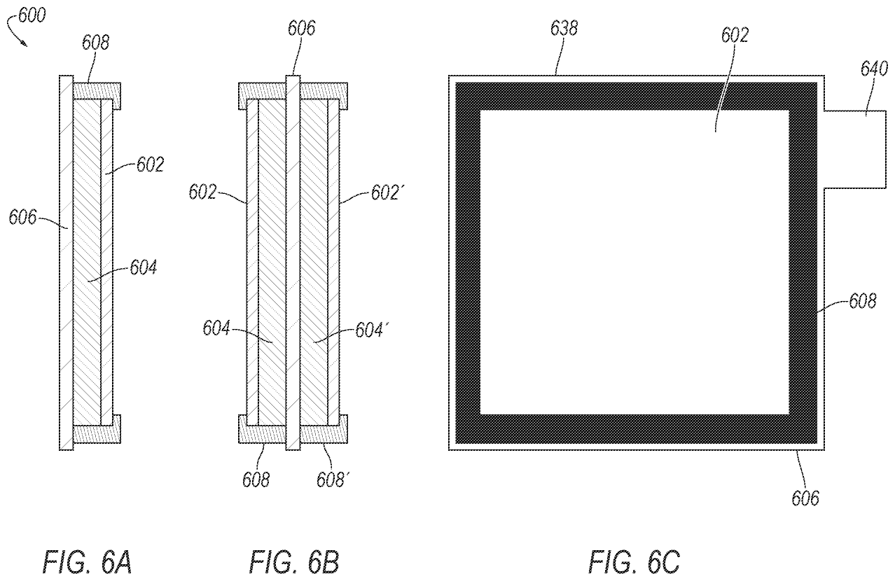

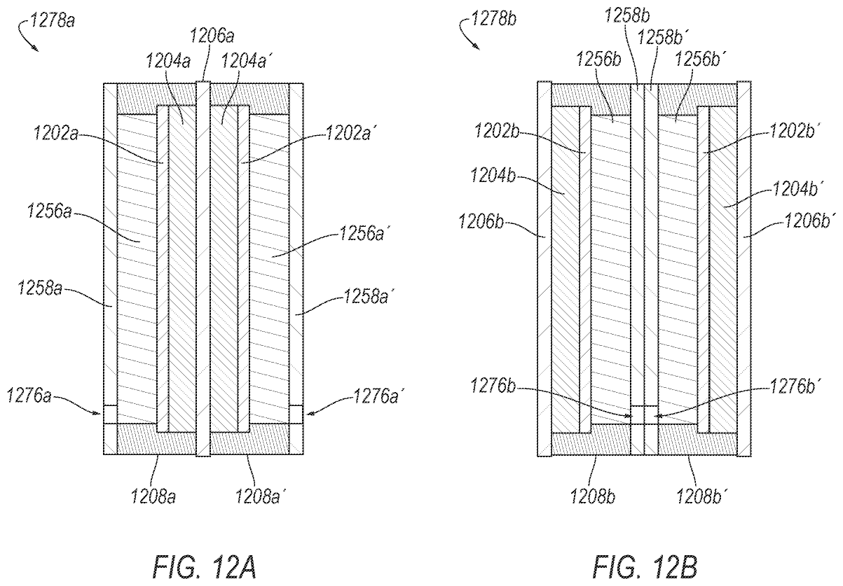

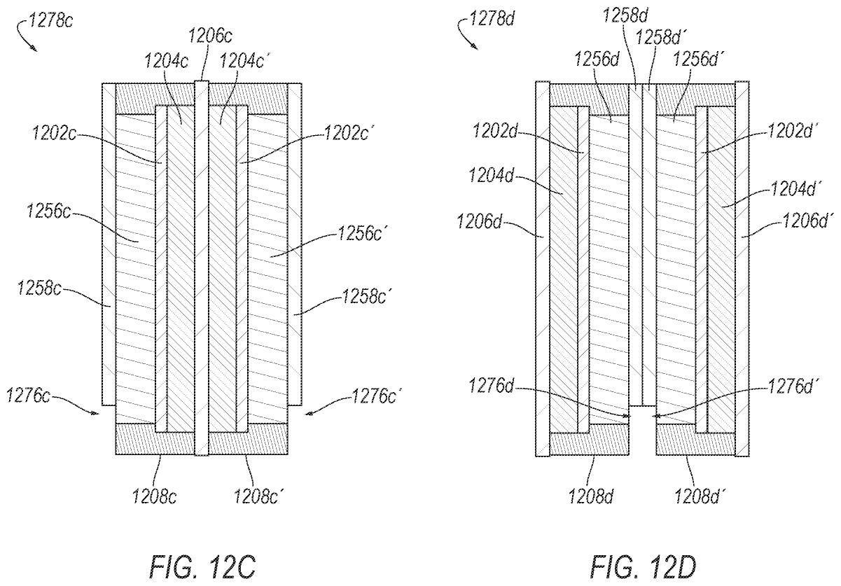

Like reference numerals in the various drawings indicate like elements. For example, the separator layer may be referred to as 102 in FIG. 1A, as 602 in FIG. 6A, and 1202a, 1202a′ in FIG. 12A.

### DETAILED DESCRIPTION

The present invention provides an anode assembly for a battery call, a battery cell comprising such an anode assembly, methods of forming such an anode assembly, a multi-layer anode assembly, and an electrode pair assembly.

As used herein, the following definitions shall apply unless otherwise indicated.

### I. DEFINITIONS

The terminology used herein is for the purpose of describing particular exemplary configurations only and is not intended to be limiting. As used herein, the singular articles “a.” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

As used herein, when an element is referred to as being “on,” “engaged to,” “connected to,” “attached to,” or “coupled to” another element, it may be directly on, engaged, connected, attached, or coupled to the other element, or intervening elements may be present. In contrast, when an element is referred to as being “directly on.” “directly engaged to,” “directly connected to,” “directly attached to,” or “directly coupled to” another element, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As used herein, the term “battery cell” refers to a rechargeable secondary cell. In some embodiments, the battery cell may be a solid-state lithium-ion battery cell.

As used herein, the term “anode assembly” refers to an assembly comprising a separator layer, an anode layer, and an anode current collector.

As used herein, the term “separator layer” refers to a layer disposed between an anode layer and a cathode layer in a battery cell and that permits cations (e.g., lithium cations) to flow between the anode and cathode layers. In some embodiments, the separator layer is substantially free of pores (e.g., having an apparent porosity of less than 50%, having an apparent porosity of less than 40%, having an apparent porosity of less than 30%, having an apparent porosity of less than 20%, having an apparent porosity of less than 15%, having an apparent porosity of less than 10%, having an apparent porosity of less than 5%, or having an apparent porosity of less than 1%). And, in some embodiments, the separator layer is free of pores.

As used herein, the term “anode layer” refers to a negative electrode layer from which electrons flow during the discharging phase of a battery cell. The anode layer is at least partially disposed on the separator layer and has a first surface facing the separator layer and a second surface facing away from the separator layer. The anode layer comprises a solid-state electrolyte (SSE) material having pores.

As used herein, the term “bi-layer” refers to the anode layer disposed on the separator layer.

As used herein, the term “anode current collector” refers to a current collector coupled to the anode layer. The anode current collector is configured to be electrically coupled to the anode layer during operation of the battery cell (e.g., charging and/or discharging of the battery cell). In some embodiments, the anode current collector comprises a metal foil. In other embodiments, the anode current collector comprises a tab configured to connect with an external circuit.

As used herein, the term “cathode layer” refers to a positive electrode layer into which electrons flow during the discharging phase of the battery cell.

As used herein, the term “cathode current collector” refers to a current collector coupled to the cathode layer. The cathode current collector is configured to be electrically coupled to the cathode layer during operation of the battery cell (e.g., charging and/or discharging of the battery cell). In some embodiments, the cathode current collector comprises a metal foil. In other embodiments, the cathode current collector comprises a tab configured to connect with an external circuit.

As used herein, the term “seal” refers to a layer that is substantially impervious to liquid (e.g., a liquid catholyte) and that restricts flow of liquid into the anode layer. As used herein, the term “substantially impervious” means that the seal is resistant to liquid penetration. In other words, liquid cannot pass freely through the seal. The seal may restrict flow of a catholyte (e.g., a liquid catholyte) into the anode layer. In this manner, the seal may reduce the likelihood of a battery cell failure resulting from catholyte leakage into the anode layer. In some embodiments, the seal is pervious to gas.

As used herein, the term “apparent porosity” refers to the open (or accessible) porosity (i.e., porosity that excludes volume(s) from sealed or closed pores, cells, or voids). Apparent porosity can be represented as a fraction or percentage of the volume of open pores, cells, or voids over the total volume.

### II. ANODE ASSEMBLY

In one aspect, the present invention provides an anode assembly for a battery cell.

As shown in FIG. 1A, the anode assembly 100 comprises a separator layer 102, an anode layer 104, an anode current collector 106, and a seal 108.

### A. Separator Layer

The separator layer may be comprised of any suitable material that permits cations (e.g., lithium cations) to flow between anode and cathode layers during operation of a battery cell. In some embodiments, the separator layer comprises a solid-state electrolyte (SSE) material. For example, the SSE material of the separator layer may comprise a polymer, a sulfide, an oxide, a chalcogenide, or any combination thereof. For example, the SSE material may comprise a sulfide. In some embodiments, the SSE material comprises LSS, LTS, LXPS, LXPSO, LATS, lithium garnets, or any combination thereof, wherein X is Si, Ge, Sn, As, Al, or any combination thereof, wherein S is S, Si, or any combination thereof, and wherein T is Sn.

As used herein, “LSS” refers to lithium silicon sulfide which can be described as Li₂S—SiS₂, Li—SiS₂, Li—S—Si, or a SSE material comprising Li, S, and Si. In some embodiments, LSS comprise LiₓSi_{y}S_{z}, wherein 0.33≤x≤0.5, 0.1≤y≤0.2, and 0.437≤0.55. In some embodiments, LSS may comprise up to 10 atomic % oxygen. In other embodiments, LSS may comprise a SSE material comprising Li, Si, and S. In some embodiments, LSS comprises a mixture of Li₂S and SiS₂. In some embodiments, a molar ratio of Li₂S:SiS₂ is 90:10, 85:15, 80:20, 75:25, 70:30, 2:1, 65:35, 60:40, 55:45, or 50:50. In some embodiments, LSS may further comprise a doped compound such as LiₓPO_{y}, LiₓBO_{y}, Li₄SiO₄, Li₃MO₄, Li₃MO₃, PS, and/or lithium halides such as, but not limited to, LiI, LiCl, LiF, or LiBr, wherein 0<x≤5 and 0<y≤5.

As used herein, “LTS” refers to a lithium tin sulfide compound which can be described as Li₂S—SnS₂, Li₂S—SnS, Li—S—Sn, or an SSE material comprising Li, S, and Sn. In some embodiments. LTS may comprise LiₓSn_{y}S_{z}, wherein 0.25≤x≤0.65, 0.05≤y≤0.2, and 0.25≤z≤0.65. In some embodiments, LTS may comprise a mixture of LizS and SnS₂ in a molar ratio (i.e., Li₂S:SnS₂) of 80:20, 75:25, 70:30, 2:1, or 1:1. In some embodiments, LTS may comprise up to 10 atomic % oxygen. In other embodiments, LTS may be doped with Bi, Sb, As, P, B, Al, Ge, Ga, In, or any combination thereof. As used herein, “LATS” refers to LTS, as used above, and further comprising Arsenic (As).

As used herein, “LXPS” refers to a material characterized by the formula LiₐMP_{b}S_{c}, wherein M is Si, Ge, Sn, Al, or any combination thereof, and wherein 2≤a≤8, 0.5≤b≤2.5, and 4≤c≤12. “LSPS” refers to an electrolyte material characterized by the formula LaSiPbSc, where 2≤a≤8, 0.5≤b≤2.5, 4≤c≤12.

When M is Sn and Si (i.e., both Sn and Si are present), the LXPS material is referred to as “LSTPS”. As used herein, “LSTPSO” refers to LSTPS that is doped with, or has, O present. In some embodiments, “LSTPSO” is a LSTPS material with an oxygen content between 0.01 and 10 atomic %. As used herein, “LSPS” refers to an electrolyte material having Li, Si, P, and S chemical constituents. As used herein “LSTPS,” refers to an electrolyte material having Li, Si, P, Sn, and S chemical constituents. As used herein, “LSPSO,” refers to LSPS that is doped with, or has, O present. In some embodiments, “LSPSO” is an LSPS material with an oxygen content between 0.01 and 10 atomic %. As used herein, “LATP” refers to an electrolyte material having Li, As, Sn, and P chemical constituents. As used herein “LAGP” refers to an electrolyte material having Li, As, Ge, and P chemical constituents. As used herein, “LXPSO” refers to an electrolyte material comprising LiₐMP_{b}S_{c}O_{d}, wherein M is Si, Ge, Sn, Al, or any combination thereof, and wherein 2≤a≤8, 0.5≤b≤2.5, 4≤c≤12, and d<3. LXPSO refers to LXPS, as defined above, and having oxygen doping at from 0.1 to about 10 atomic %. As used herein, “LPS” refers to an electrolyte material comprises Li₂S—P₂S₅. As used herein, “LPSO” refers to LPS, as defined herein, and further comprising oxygen doping at from 0.1 to about 10 atomic %.

In some embodiments, the SSE material of the separator layer comprises a polymer. For example, the polymer may comprise polyolefins, natural rubbers, synthetic rubbers, poly butadiene, polyisoprene, epoxidized natural rubber, polyisobutylene, polypropylene oxide, polyacrylates, polymethacrylates, polyesters, polyvinyl esters, polyurethanes, styrenic polymers, epoxy resins, epoxy polymers, poly(bisphenol A-co-epichlorohydrin), vinyl polymers, polyvinyl halides, polyvinyl alcohol, polyethyleneimine, poly(maleic anhydride), silicone polymers, siloxane polymers, polyacrylonitrile, polyacrylamide, polychloroprene, polyvinylidene fluoride, polyvinyl pyrrolidone, polyepichlorohydrin, blends thereof, or copolymers thereof. In some embodiments, the polymer is polyolefins. In some embodiments, the polymer is natural rubbers. In some embodiments, the polymer is synthetic rubbers. In some embodiments, the polymer is polybutadiene. In some embodiments, the polymer is polyisoprene. In some embodiments, the polymer is epoxidized natural rubber. In other embodiments, the polymer is polyisobutylene. In some embodiments, the polymer is polypropylene oxide. In some embodiments, the polymer is polyacrylates. In some embodiments, the polymer is polymethacrylates. In some embodiments, the polymer is polyesters. In other embodiments, the polymer is polyvinyl esters. In some embodiments, the polymer is polyurethanes. In some embodiments, the polymer is styrenic polymers. In some embodiments, the polymer is epoxy resins. In some embodiments, the polymer is epoxy polymers. In some embodiments, the polymer is poly(bisphenol A-co-epichlorohydrin). In some embodiments, the polymer is vinyl polymers. In some embodiments, the polymer is polyvinyl halides. In some embodiments, the polymer is polyvinyl alcohol. In some embodiments, the polymer is polyethyleneimine. In other embodiments, the polymer is poly(maleic anhydride). In some embodiments, the polymer is silicone polymers. In some embodiments, the polymer is siloxane polymers. In some embodiments, the polymer is polyacrylonitrile. In some embodiments, the polymer is polyacrylamide. In some embodiments, the polymer is polychloroprene. In some embodiments, the polymer is polyvinylidene fluoride. In some embodiments, the polymer is polyvinyl pyrrolidone. In some embodiments, the polymer is polyepichlorohydrin. In some embodiments, a molecular weight of the polymer is greater than about 50,000 g/mol.

In some embodiments, the polymer is preformed and selected from the group consisting of polypropylene, polyethylene, polybutadiene, polyisoprene, epoxidized natural rubber, poly(butadiene-co-acrylonitrile), polyethyleneimine, polydimethylsiloxane, and poly(ethylene-co-vinyl acetate). In other embodiments, a molecular weight of the polymer is greater than about 50,000 g/mol.

When the SSE material comprises a polymer, the SSE material may further comprise a metal salt (e.g., a lithium salt (e.g., LiPF₆)).

In some embodiments, the SSE material of the separator layer comprises a lithium perovskite material, Li₃N, Li-β-alumina, Lithium Super-ionic Conductors (LISICON), Li_{2.88}PO_{3.86}N_{0.14} (LiPON), Li₉AlSiO₈, Li₁₀GeP₂S₁₂, lithium garnet SSE materials, doped lithium garnet SSE materials, lithium garnet composite materials, or any combination thereof. In various embodiments, the lithium garnet SSE material is cation-doped Li₅La₃M¹₂O₁₂, where M¹ is Nb, Zr, Ta, or any combination thereof, cation-doped Li₆La₂BaTa₂O₁₂, cation-doped Li₇La₃Zr₂O₁₂, and cation-doped Li₆BaY₂M¹₂O₁₂, where cation dopants are barium, yttrium, zinc, or combinations thereof, and the like. In various other embodiments, the lithium garnet SSE material is Li₅La₃Nb₂O₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}Ta_{0.6}O₁₂, Li_{6.5}La_{2.5}Ba_{0.5}TaZrO₁₂, Li₆BaY₂M¹₂O₁₂, Li₇Y₃Zr₂O₁₂, Li_{6.75}BaLa₂Nb_{1.75}Zn_{0.25}O₁₂, Li_{6.75}BaLa₂Ta_{1.75}Zn_{0.25}O₁₂, or any combination thereof.

In some embodiments, the SSE material of the separator layer and the SSE material of the anode layer are the same (e.g., the SSE material of the separator layer may be any SSE material described herein for the anode layer). In other embodiments, the SSE material of the separator layer and the SSE material of the separator layer are different.

In some embodiments, the separator layer is substantially free of pores (e.g., having an apparent porosity of less than 50%, having an apparent porosity of less than 40%, having an apparent porosity of less than 30%, having an apparent porosity of less than 20%, having an apparent porosity of less than 15%, having an apparent porosity of less than 10%, having an apparent porosity of less than 5%, or having an apparent porosity of less than 1%). And, in some embodiments, the separator layer is free of pores.

In some embodiments, the separator layer has a thickness of from about 1 μm to about 300 μm. In some embodiments, the separator layer has a thickness of from about 1 μm to about 200 μm. In other embodiments, the separator layer has a thickness of from about 1 μm to about 100 μm. In some embodiments, the separator layer has a thickness of from about 1 μm to about 50 μm. In some embodiments, the separator layer has a thickness of from about 1 μm to about 20 μm. And, in some embodiments, the separator layer has a thickness of from about 1 μm to about 10 μm.

With reference again to FIG. 1A, the separator layer has a front surface 110 facing the anode layer, a back surface 112 facing away from the anode layer and an outer surface 114 extending from the front surface to the back surface.

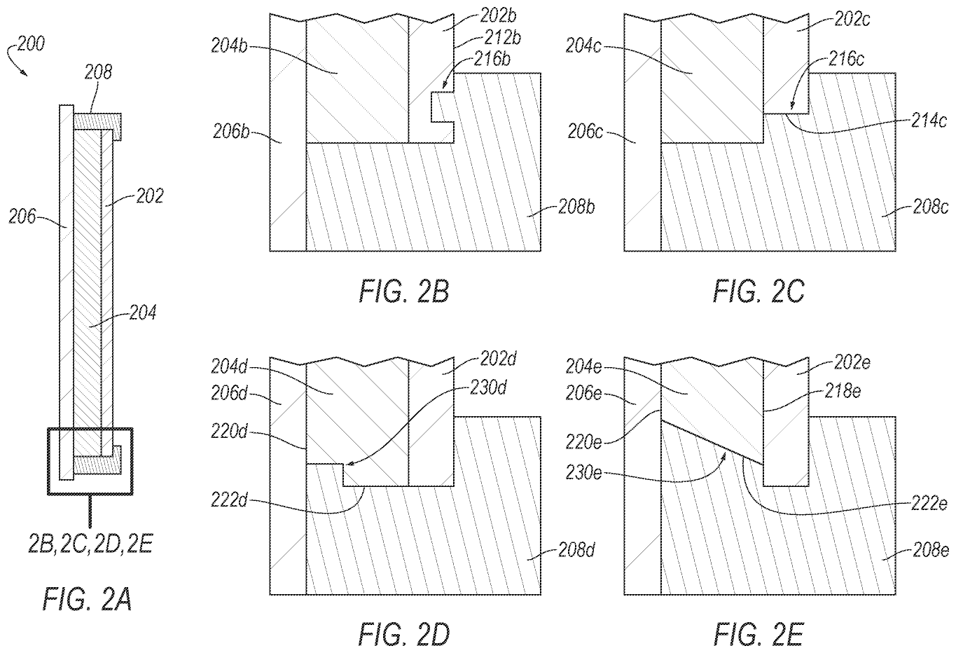

In some embodiments, the separator layer may define a recess 216b, 216c, as shown in FIGS. 2B and 2C. The recess of the separator layer may be defined on the front surface, back surface, and/or the outer surface of the separator layer. For example, the back surface 212b of the separator layer may define the recess, as shown in FIG. 2B. In other embodiments, the back surface and the outer surface 214c of the separator layer define the recess, as shown in FIG. 2C.

When the separator layer defines the recess, the seal may be disposed in the recess. Without wishing to be bound by theory, it is believed that the recess increases a surface area for the seal to bond to. Additionally, it is believed that disposing the seal in the recess of the separator layer creates a more tortuous path through which liquid must flow in order to penetrate the anode layer.

### B. Anode Layer

With reference again to FIG. 1A, the anode layer is at least partially disposed on the separator layer. In some embodiments, the anode layer has a first surface 118 facing the separator layer, a second surface 120 facing away from the separator layer, and an outer surface 122 extending from the first surface to the second surface. The anode layer comprises a SSE having pores.

In some embodiments, the anode layer is disposed on an entire surface of the separator layer. In other embodiments, the anode layer is disposed on substantially all (e.g., at least 60%, at least 70%, at least 80%, at least 90%, or at least 95%) of a surface of the separator layer. And, in other embodiments, the anode layer is disposed only on a portion of a surface of the separator layer.

In some embodiments, the anode layer has an apparent porosity of from about 20% to about 80%. In other embodiments, the anode layer has an apparent porosity of from about 35% to about 75%. In some embodiments, the anode layer has an apparent porosity of from about 45% to about 65%. In some embodiments, the anode layer has an apparent porosity of from about 50% to about 60%. In some embodiments, the anode layer has an apparent porosity of from about 60% to about 80%. In some embodiments, the anode layer has an apparent porosity of from about 20% to about 95%. And, in some embodiments, the anode layer has an apparent porosity of from about 50% to about 90%.

In some embodiments, the SSE material of the anode layer and the SSE material of the separator layer are the same. In other embodiments, the SSE material of the anode layer and the SSE material of the separator layer are different. In some embodiments the SSE material comprises a lithium conductor, a sodium conductor, or a magnesium conductor. In some embodiments the SSE material comprises a lithium conductor. In other embodiments, the SSE material comprises a sodium conductor. And, in some embodiments, the SSE material comprises a magnesium conductor.

In some embodiments, the SSE material of the anode layer may comprise a garnet material. Non-limiting examples of garnet materials include lithium garnet materials, doped lithium garnet materials, lithium garnet composite materials, and combinations thereof. Non-limiting examples of lithium garnet materials include Li₃-phase lithium garnet SSE materials (e.g., Li₃M¹Te₂O₁₂, where M¹ is a lanthanide such as Y, Pr, Nd, Sm, Eu, Gd, Tb, Dy, Ho, Er, Tm, Yb, Lu, Zr, Ta, or a combination thereof and Li₃₊ₓNd₃Te₂₋ₓO₁₂, where x is 0.05 to 1.5; Li₅-phase lithium garnet SSE materials (e.g., Li₅La₃M²₂O₁₂, where M² is Nb, Zr, Ta, Sb, or a combination thereof, cation-substituted Li₅La₃M²₂O₁₂ such as, for example, Li₆M¹La₃M²₂O₁₂, where M¹ is Mg, Ca, Sr, Ba, or combinations thereof, and Li₇La₃M²₂O₁₂, where M² is Zr, Sn, or a combination thereof); Li₆-phase lithium garnet SSE materials (e.g., Li₆M¹La₂M²₂O₁₂, where M¹ is Mg, Ca, Sr, Ba, or a combination thereof and M₂ is Nb, Ta, or a combination thereof); cation-doped Li₆La₂BaTa₂O₁₂; cation-doped Li₆BaY₂M²₂O₁₂, where M² is Nb, Ta, or a combination thereof and the cation dopants are barium, yttrium, zinc, or combinations thereof, an Li₇-phase lithium garnet SSE material (e.g., cubic Li₇La₃Zr₂O₁₂ and Li₇Y₃Zr₂O₁₂); cation-doped Li₇La₃Zr₂O₁₂; Li₅₊₂ₓLa₃, Ta₂₋ₓO₂, where x is 0.1 to 1, Li_{6.8}(La_{2.95}, Ca_{0.5}) (Zr_{1.75}, Nb_{0.25})O₁₂ (LLCZN), Li_{6.4}Y₃Zr_{1.4}T_{a0.6}O₁₂, Li_{6.5}La_{2.5}Ba_{0.5}TaZrO₁₂, Li₆BaY₂M¹₂O₁₂, Li₇Y₃Zr₂O₁₂, Li_{6.75}BaLa₂Nb_{1.75}Zn_{0.25}O₁₂, or Li_{6.75}BaLa₂Ta_{1.75}Zn_{0.25}O₁₂), lithium garnet composite materials (e.g., lithium garnet-conductive carbon matrix or composites with other materials). Other examples of lithium-ion-conducting SSE materials include cubic garnet-type materials such as 3 mol % YSZ-doped Li_{7.6}La₃Zr_{1.94}Y_{0.06}O₁₂ and 8 mol % YSZ-doped Li_{7.16}La₃Zr_{1.94}Y_{0.06}O₁₂. Additional examples of suitable lithium garnet SSE materials include, but are not limited to, Li₅La₃Nb₂O₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4} Y₃Zr_{1.4}Ta_{0.6}O₁₂, Li_{6.5}La_{2.5}Ba_{0.5}TaZrO₁₂, Li₇Y₃Zr₂O₁₂, Li_{6.75}BaLa₂Nb_{1.75}Zn_{0.25}O₁₂, or Li_{6.75}BaLa₂Ta_{1.75}Zn_{0.25}O₁₂. In some embodiments, the garnet material is, for example, Li₇₋ₓLa_{3-y} M¹_{y}Zr_{2-z}M²_{z}O₁₂, wherein x greater than 0 and less than 2, M¹ is chosen from Ba, Ca, Y, and combinations thereof, and M₂ is chosen from Nb, Ta, and combinations thereof. In some embodiments, the garnet material is Li_{6.75}La₃Zr_{1.75}Ta_{0.25}O₁₂ (LLZT), Li_{6.75}La_{2.75}Zr_{1.75}Ca_{0.25}Nb_{0.25}O₁₂ (LLZCN), Li₅La₃Nb₂O₁₂ (LLZNO), Li₇La₃Zr₂O₁₂ (LLZ), Li₅La₃Ta₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}Ta_{0.6}O₁₂, Li_{6.5}La_{2.5}Ba_{0.5}TaZrO₁₂, Li₆BaY₂M¹₂O₁₂, Li_{6.75}BaLa₂Nb_{1.75}Zn_{0.25}O₁₂, Li_{6.75}BaLa₂Ta_{1.75}Zn_{0.25}O₁₂, or any combination thereof.

In some embodiments, the garnet material comprises a composition of Formula (I):

M1₇₋ₓD1ₐM2_{3-y}D2_{b}M3_{2-z}D3_{c}O_{12-w}D4_{d} (I)

wherein
M1 is Li;
M2 is La;
M3 is Zr;
D1 is H, Be, B, Al, Fe, Zn, Ga, Ge, or any combination thereof;
D2 is Na, K, Ca, Rb, Sr, Y, Ag, Ba, Bi, Pr, Nd, Pm, Sm, Gd, Tb, Dy, Ho, Er, Tm, Zn, Ce, or any combination thereof;
D3 is Mg, Si, Sc, Ti, V, Cr, Mn, Co, Ni, Cu, Ge, As, Se, Nb, Mo, Tc, Ru, Rh, Pd, Cd, In, Sn, Sb, Hf, Ta, W, Ir, Pt, Au, Hg, Tl, Pb, Ce, Eu, Te, Y, Sr, Ca, Ba, Gd, Ge, or any combination thereof; and
D4 is F, Cl, Br, I, S, Se, Te, N, P, or any combination thereof;
   provided that
0≤w≤2;
−0.5<x≤3;
0≤y≤3;
0≤z≤2;
0≤a≤2;
0≤b≤3;
0≤c≤2; and
0≤d≤2;
   wherein at least one of a, b, c, and d is >0.

In some embodiments, the anode layer further comprises an anode material disposed in at least a portion of the pores of the anode layer. In some embodiments, the anode material comprises a lithium-containing material, a magnesium-containing material, a sodium-containing material, or any combination thereof. In other embodiments, the anode material comprises lithium metal, sodium metal, magnesium metal, or any combination thereof. In some embodiments, the anode material comprises lithium metal. In other embodiments, the anode material comprises sodium metal. And, in some embodiments, the anode material comprises magnesium metal.

In some embodiments, the pores of the anode layer are substantially free of an anode material (e.g., the pores comprise less than 1%, less than 0.5%, less than 0.25%, less than 0.1%, less than 0.01%, or less than 0.001% of the anode material by volume of the pores). In the context of this disclosure, when the pores of the anode layer are referred to as “substantially free of”, or “free of”, the anode material, it will be appreciated that the pores of the anode layer are substantially free, or free, of the anode material prior to operation of the battery cell, i.e., immediately after fabrication of the battery cell and prior to operation of the battery cell (e.g., charging/discharging of the battery cell). In some embodiments, the pores of the anode layer are substantially free of lithium metal, sodium metal, magnesium metal, or any combination thereof. In other embodiments, the pores of the anode layer are free of lithium metal, sodium metal, magnesium metal, or any combination thereof. In some embodiments, the pores of the anode layer are substantially free of lithium metal. And, in some embodiments, the pores of the anode layer are free of lithium metal.

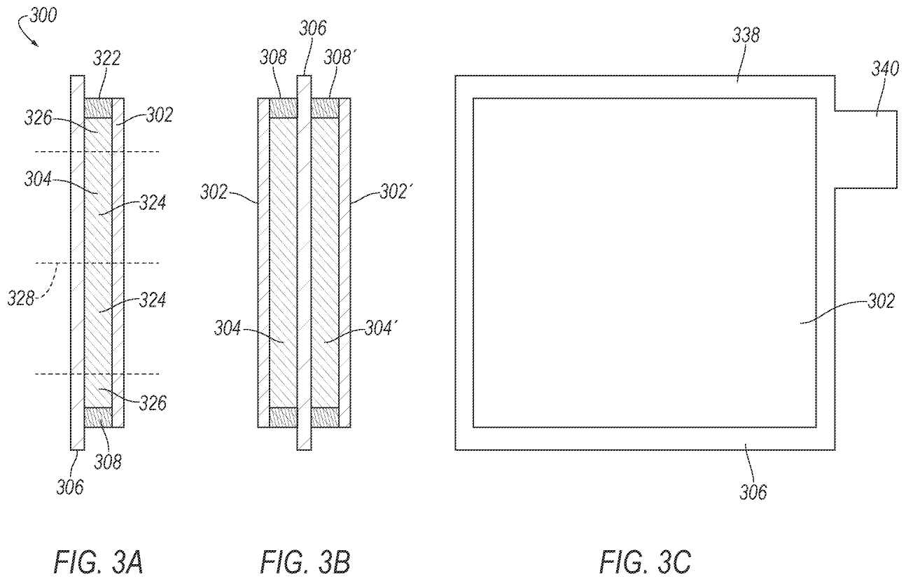

As shown in FIG. 3A, in some embodiments, the anode layer defines a first porous region 324 and a second porous region 326. The first porous region is defined between a center 328 and the outer surface of the anode layer. The second porous region is defined between the first porous region and the outer surface of the anode layer.

In some embodiments, the pores of the first porous region are substantially free of the sealant material (e.g., the pores comprise less than 1%, less than 0.5%, less than 0.25%, less than 0.1%, less than 0.01%, or less than 0.001% of the sealant material by volume of the pores). In other embodiments, the pores of the first porous region are free of the sealant material.

In some embodiments, at least a portion of the pores of the second porous region comprise the sealant material, as shown in FIG. 3A.

With reference to FIGS. 2D and 2E, the anode layer may define a recess 230d, 230e. The recess of the anode layer may be defined on the first surface, the second surface, and/or the outer surface of the anode layer. For example, the second surface 220d and the outer surface 222d of the anode layer may define the recess, as shown in FIG. 2D. In some embodiments, the first surface 218e, the second surface 220e, and the outer surface 222e of the anode layer define the recess, as shown in FIG. 2E. In other embodiments, only the outer surface defines the recess. In some embodiments, only the second surface defines the recess. And, in some embodiments, only the first surface defines the recess.

When the anode layer defines the recess, the seal may be disposed in the recess, as shown in FIGS. 2D and 2E. Without wishing to be bound by theory, it is believed that the recess increases a surface area for the seal to bond to. Additionally, it is believed that disposing the seal in the recess of the anode layer creates a more tortuous path through which liquid must flow in order to penetrate the anode layer.

In some embodiments, the anode layer has a thickness of from about 1 μm to about 500 μm. In some embodiments, the anode layer has a thickness of from about 1 μm to about 200 μm. In other embodiments, the anode layer has a thickness of from about 1 μm to about 100 μm. In some embodiments, the anode layer has a thickness of from about 1 μm to about 50 μm. And, in some embodiments, the anode layer has a thickness of from about 1 μm to about 20 μm.

### C. Anode Current Collector

The anode current collector is coupled to the anode layer. With reference again to FIG. 1A, the anode current collector is coupled to the second surface of the anode layer. In some embodiments, the anode current collector has an interior surface 132 facing the anode layer, an exterior surface facing 134 away from the anode layer, and an outer surface 136 extending from the interior surface to the exterior surface.

In some embodiments, the anode current collector is at least partially disposed on the second surface of the anode layer. In some embodiments, the anode current collector is disposed on the entire second surface of the anode layer. In other embodiments, the anode current collector is disposed on substantially all (e.g., at least 60%, at least 70%, at least 80%, at least 90%, or at least 95%) of the second surface of the anode layer. And, in other embodiments, the anode current collector is disposed only on a portion of the second surface of the anode layer.

In some embodiments, the anode current collector comprises a metal foil 138, as shown in FIGS. 1A and 1C. In such embodiments, the metal foil is at least partially disposed on the second surface of the anode layer. In some embodiments, the metal foil is disposed on the entire second surface of the anode layer. In other embodiments, the metal foil is disposed on substantially all (e.g., at least 60%, at least 70%, at least 80%, at least 90%, or at least 95%) of the second surface of the anode layer. And, in other embodiments, the metal foil is disposed only on a portion of the second surface of the anode layer.

In some embodiments, the metal foil has a tab 140 configured to connect with an external circuit, as shown in FIG. 1C. In the illustrated embodiment, the tab is integral with the metal foil. In other embodiments, the tab is coupled (e.g., welded) to the metal foil.

In some embodiments, the anode current collector comprises a tab configured to connect with an external circuit. In such embodiments, the anode current collector may comprise a tab alone and not the metal foil. For example, the anode current collector may comprise the tab and the tab may be coupled to the seal (e.g., disposed in the seal).

The anode current collector may be comprised of any suitable material. In some embodiments, the anode current collector (e.g., the metal foil and/or the tab) comprises copper, nickel, titanium, stainless steel, alloys thereof, or any combination thereof. In some embodiments, the anode current collector comprises copper. In other embodiments, the anode current collector comprises a copper alloy. In some embodiments, the anode current collector comprises nickel. In other embodiments, the anode current collector comprises a nickel alloy. In some embodiments, the anode current collector comprises titanium. In some embodiments, the anode current collector comprises a titanium alloy. In some embodiments, the anode current collector comprises stainless steel. And, in some embodiments, the anode current collector comprises a stainless steel alloy.

In some embodiments, the anode current collector comprises an electronically conductive film. For example, the electronically conductive film may comprise a polymer material and a conductive material. For example, the conductive material may be a metal material. In some embodiments, the conductive material comprises copper, nickel, titanium, stainless steel, alloys thereof, or any combination thereof. In some embodiments, the polymer comprises polypropylene, polyethylene, polymethylpentene, poly butene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof.

In some embodiments, electronically conductive tape couples the anode current collector to the anode layer. During operation of the battery cell (e.g., charging and/or discharging of the battery cell), the electronically conductive tape may electrically couple the anode current collector to the anode layer.

### D. Seal

The seal comprises a sealant material. The seal is substantially impervious to liquid. In some embodiments, the seal is substantially impervious to liquid and pervious to gas. When the seal is substantially impervious to liquid and pervious to gas, the seal may restrict flow of a liquid (e.g., a liquid catholyte) into the anode layer while permitting venting of gases from the anode layer.

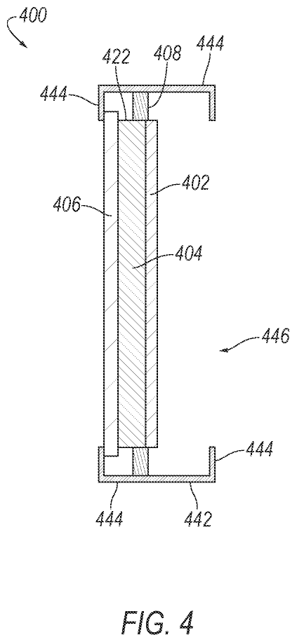

In some embodiments, the seal is at least partially disposed on the outer surface of the anode layer. In some embodiments, the seal 108 is disposed on the entire outer surface of the anode layer, as shown in FIG. 1A. In other embodiments, the seal is disposed on substantially all (e.g., at least 60%, at least 70%, at least 80%, at least 90%, or at least 95%) of the outer surface of the anode layer. And, in other embodiments, the seal 408 is disposed only on a portion of the outer surface of the anode layer, as shown in FIG. 4.

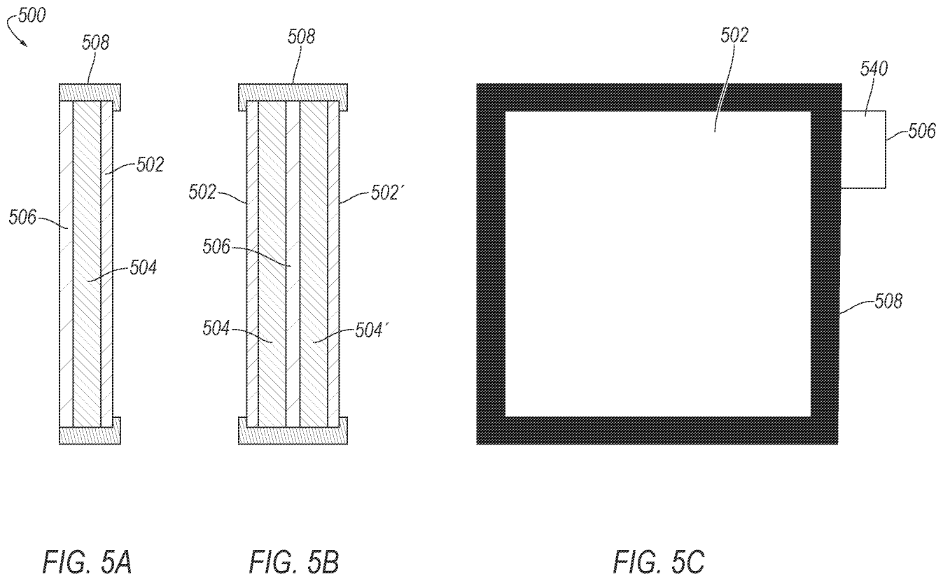

In some embodiments, the seal 208, 508, 608 is at least partially disposed on the separator layer, as shown in FIGS. 2A, 5A, and 6A. In some embodiments, the seal is at least partially disposed on the outer surface of the separator layer. In some embodiments, the seal 508, 608 is disposed on the entire outer surface of the separator layer, as shown in FIGS. 5A and 6A. In other embodiments, the seal is disposed on substantially all (e.g., at least 60%, at least 70%, at least 80%, at least 90%, or at least 95%) of the outer surface of the separator layer. And, in some embodiments, the seal is disposed only on a portion of the outer surface of the separator layer.

In some embodiments, the seal is at least partially disposed on the back surface of the separator layer. In other embodiments, the seal is disposed on substantially all (e.g., at least 60%, at least 70%, at least 80%, at least 90%, or at least 95%) of the back surface of the separator layer. And, in other embodiments, the seal 208, 508, 608 is disposed only on a portion of the back surface of the separator layer, as shown in FIGS. 2A, 5A, and 6A.

In some embodiments, the seal is at least partially disposed on the front surface of the separator layer. In other embodiments, the seal is disposed on substantially all (e.g., at least 60%, at least 70%, at least 80%, at least 90%, or at least 95%) of the front surface of the separator layer. And, in other embodiments, the seal 208e is disposed only on a portion of the front surface of the separator layer, as shown in FIG. 2E.

In some embodiments, the seal 508, 608 is disposed at least partially on the outer surface and the back surface of the separator layer, as shown in FIGS. 5A and 6A. In the illustrated embodiments, the seal is disposed on the entire outer surface and only a portion of the back surface of the separator layer. In other embodiments, the seal 208e is disposed at least partially on the outer surface, the front surface, and the back surface of the separator layer, as shown in FIG. 2E. As illustrated, the seal is disposed on the entire outer surface and only a portion of the front and back surfaces of the separator layer.

In other embodiments, the separator layer is free of the seal. In other words, the seal is not disposed on any surface (e.g., the front surface, the back surface, and/or the outer surface) of the separator layer.

In some embodiments, the seal 108, 508, 608 is at least partially disposed on the anode current collector, as shown in FIGS. 1A, 5A, and 6A. In some embodiments, the seal is at least partially disposed on the outer surface of the anode current collector. In some embodiments, the seal 508 is disposed on the entire outer surface of the anode current collector, as shown in FIG. 5A. In other embodiments, the seal is disposed on substantially all (e.g., at least 60%, at least 70%, at least 80%, at least 90%, or at least 95%) of the outer surface of the anode current collector. And, in some embodiments, the seal is disposed only on a portion of the outer surface of the anode current collector.

In some embodiments, the seal is at least partially disposed on the interior surface of the anode current collector. In other embodiments, the seal is disposed on substantially all (e.g., at least 60%, at least 70%, at least 80%, at least 90%, or at least 95%) of the interior surface of the anode current collector. And, in other embodiments, the seal 108, 608 is disposed only on a portion of the interior surface of the anode current collector, as shown in FIGS. 1A and 6A.

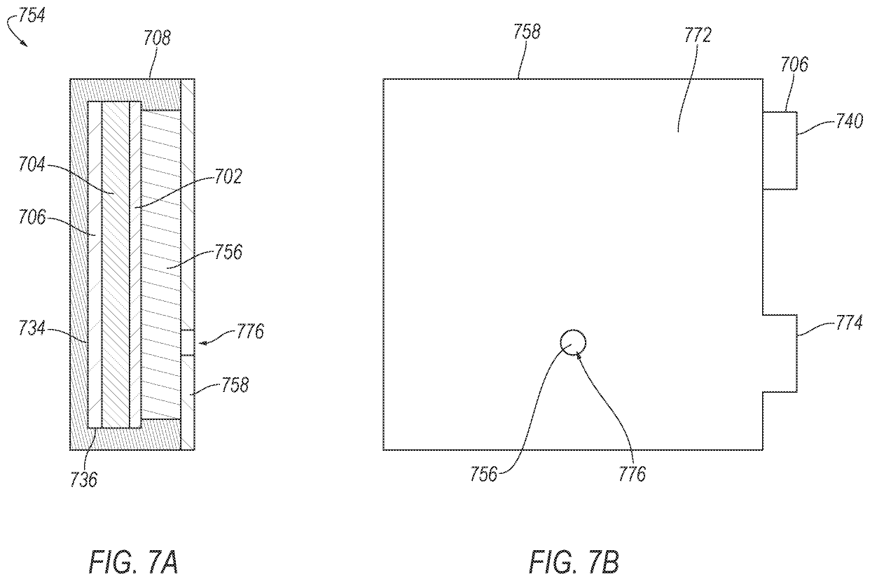

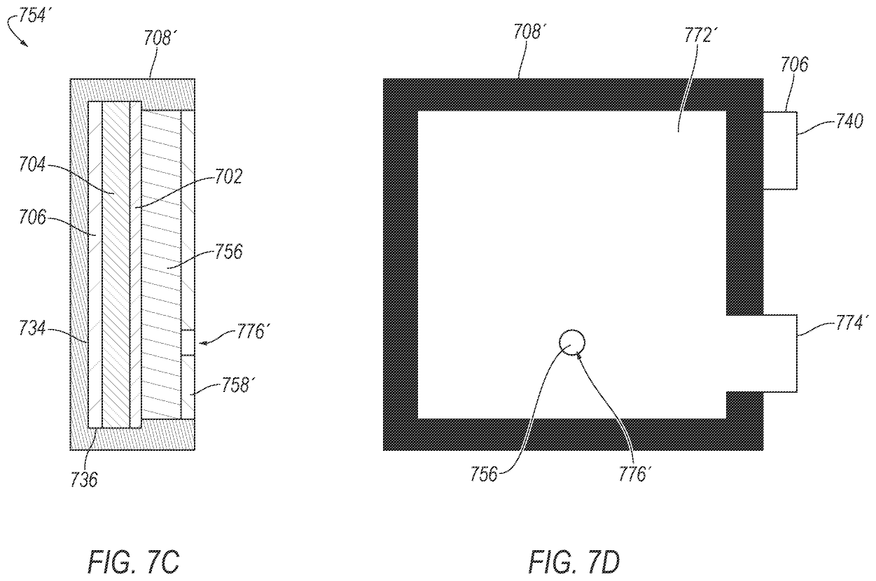

In some embodiments, the seal is at least partially disposed on the exterior surface of the anode current collector. In some embodiments, the seal 708, 708′ is disposed on the entire exterior surface of the anode current collector, as shown in FIGS. 7A and 7C. In other embodiments, the seal is disposed on substantially all (e.g., at least 60%, at least 70%, at least 80%, at least 90%, or at least 95%) of the exterior surface of the anode current collector. And, in other embodiments, the seal is disposed only on a portion of the outer surface of the anode current collector.

In some embodiments, the seal 708, 708′ is at least partially disposed on the exterior surface and the outer surface of the anode current collector, as shown in FIGS. 7A and 7C. In the illustrated embodiments, the seal is disposed on the entire exterior and outer surfaces of the anode current collector.

In other embodiments, the anode current collector is free of the seal. In other words, the seal is not disposed on any surface (e.g., the interior surface, the exterior surface, and/or the outer surface) of the anode current collector.

In some embodiments, the seal 508 is at least partially disposed on each of the outer surface of the anode layer, the outer surface of the separator layer, and the outer surface of the anode current collector, as shown in FIG. 5A. In other embodiments, the seal 708,708′ is at least partially disposed on each of the outer surface of the anode layer, the outer surface of the separator layer, the outer surface of the anode current collector, and the exterior surface of the anode current collector, as shown in FIGS. 7A and 7C. And, in some embodiments, the seal 608 is at least partially disposed on each of the outer surface of the anode layer, the outer surface of the separator layer, and the interior surface of the anode current collector, as shown in FIG. 6A.

With reference to FIG. 3A, the seal 308 may be at least partially disposed on the outer surface of the anode layer and in the pores of the second porous region of the anode layer. In embodiments where the seal is disposed in the pores of the anode layer (e.g., a portion of the pores of the second porous region), the seal may also restrict flow of anode active material (e.g., lithium metal) outside of the anode layer.

The sealant material may be any material suitable for restricting flow of a liquid (e.g., a liquid catholyte) into the anode layer. In some embodiments, the sealant material comprises a non-conductive (e.g., non-ionically conductive and non-electronically conductive) polymer, a non-conductive (e.g., non-ionically conductive and non-electronically conductive) glass, or any combination thereof. In other embodiments, the sealant material comprises a non-conductive polymer. In some embodiments, the sealant material comprises a non-conductive glass. For example, the sealant material may be a glass having a low coefficient of thermal expansion (CTE). As another example, the sealant material may be a glass ceramic.

In some embodiments, the sealant material comprises polypropylene, polyethylene, polyimide, polyvinyl chloride (PVC), ethylene-vinyl acetate, polyamide, polypropylene, polyurethane, copolymers thereof, or any combination thereof. For example, the sealant material may comprise polypropylene. In some embodiments, the sealant material comprises polyethylene. In other embodiments, the sealant material comprises polyimide. In some embodiments, the sealant material comprises PVC. In some embodiments, the sealant material comprises ethylene-vinyl acetate. In other embodiments, the sealant material comprises polyamide. In some embodiments, the sealant material comprises polypropylene. And, in some embodiments, the sealant material comprises polyurethane.

In some embodiments, the sealant material comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof. In some embodiments, the sealant material comprises polypropylene. In some embodiments, the sealant material comprises polyethylene. In other embodiments, the sealant material comprises polymethylpentene. In some embodiments, the sealant material comprises polybutene-1. In some embodiments, the sealant material comprises ethylene-octene copolymers. In some embodiments, the sealant material comprises propylene-butane copolymers. In some embodiments, the sealant material comprises polyisobutylene. In some embodiments, the sealant material comprises poly(α-olefin). In some embodiments, the sealant material comprises ethylene propylene rubber. In other embodiments, the sealant material comprises ethylene propylene diene monomer rubber. In some embodiments, the sealant material comprises ethylene-vinyl acetate. In some embodiments, the sealant material comprises ethylene-acrylate copolymers. In other embodiments, the sealant material comprises polyamides. In some embodiments, the sealant material comprises polyesters. In some embodiments, the sealant material comprises polyurethanes. In some embodiments, the sealant material comprises styrene block copolymers. In some embodiments, the sealant material comprises polycaprolactone. In other embodiments, the sealant material comprises polyimide. In some embodiments, the sealant material comprises polyvinyl chloride. In some embodiments, the sealant material comprises polycarbonates. In some embodiments, the sealant material comprises polyacrylates. In some embodiments, the sealant material comprises polymethacrylates. In some embodiments, the sealant material comprises fluoropolymers. In some embodiments, the sealant material comprises epoxy resins. In other embodiments, the sealant material comprises epoxy polymers. And, in some embodiments, the sealant material comprises silicone rubber.

In some embodiments, the seal may further comprise a conductive material. For example, the conductive material may be a metal material. In some embodiments, the conductive material comprises copper, nickel, titanium, stainless steel, alloys thereof, or any combination thereof.

In some embodiments, at least a portion of the seal has a thickness of from about 1 μm to about 50 μm. In some embodiments, at least a portion of the seal has a thickness of from about 1 μm to about 20 μm. In other embodiments, at least a portion of the seal has a thickness of from about 1 μm to about 10 μm. And, in some embodiments, at least a portion of the seal has a thickness of from about 1 μm to about 5 μm.

Without wishing to be bound by theory, it is believed that anode layer comprising the SSE having pores allows the seal to be disposed on the outer surface of the anode layer, the anode current collector, and/or the ceramic separator layer thereby restricting flow of liquid (e.g., a liquid catholyte) into the anode layer. Specifically, and in contrast to the other solid-state anode assemblies, the volume of the anode layer described herein remains substantially constant during cycling, and the distance between the anode layer and the anode current collector remains substantially static during cycling. For this reason, sealing of the outer surface of the anode layer, the anode current collector, and/or the ceramic separator layer is possible without risk of fatigue failure resulting from a changing volume of the anode assembly during cycling.

### E. Housing

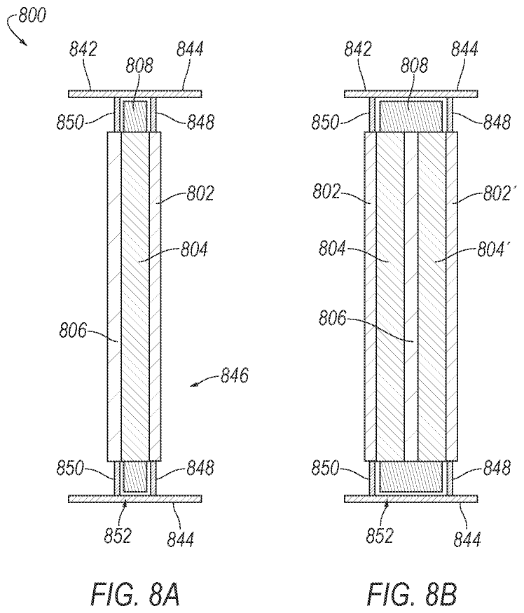

In some embodiments, the anode assembly further comprises a housing 442, 842 having a plurality of interior walls 444, 844 defining an interior 446, 846, as shown in FIGS. 4 and 8A. The separator layer, the anode layer, the anode current collector, and the seal are disposed in the interior of the housing.

With reference to FIG. 4, when the anode assembly comprises the housing, the seal 408 may extend from the outer surface 422 of the anode layer to at least one of the plurality of interior walls of the housing. In the illustrated embodiment, the seal contacts the at least one (e.g., two or more) of the plurality of interior walls. In other embodiments, the seal is spaced from the at least one of the plurality of interior walls.

With reference to FIG. 8, the housing may further comprise a first protrusion 848 and a second protrusion 850 extending from at least one of the plurality of interior walls to the interior of the housing. The first and second protrusions define a cavity 852. In some embodiments, the seal extends from the outer surface of the anode layer into the cavity.

In some embodiments, the seal may extend from the outer surface of the separator layer to at least one of the plurality of interior walls of the housing. In such embodiments, the outer surface of the anode layer may be free of the seal. In other words, the seal may not be disposed on any surface (e.g., the first surface, the second surface, and/or the outer surface) of the anode layer.

In another aspect, the present invention provides an anode assembly for a battery cell. The battery cell comprises a separator layer, an anode layer, an anode current collector, and a seal. The anode layer is at least partially disposed on the separator layer and has a first surface facing the separator layer, a second surface facing away from the separator layer, and an outer surface extending from the first surface to the second surface. The anode layer comprises a solid-state electrolyte (SSE) having pores. The anode current collector is coupled to the second surface of the anode layer. The seal is disposed on substantially all of the outer surface of the anode layer and comprises a sealant material. The seal is substantially impervious to liquid.

In a further aspect, the present invention provides an anode assembly for a battery cell. The battery cell comprises a separator layer, an anode layer, an anode current collector, and a seal. The anode layer is at least partially disposed on the separator layer and has a first surface facing the separator layer, a second surface facing away from the separator layer, and an outer surface extending from the first surface to the second surface. The anode layer comprises a solid-state electrolyte (SSE) having pores. The anode current collector is coupled to the second surface of the anode layer. The seal is disposed on at least a portion of the anode layer and the separator layer. The seal is substantially impervious to liquid.

In one aspect, the present invention provides an anode assembly for a battery cell. The battery cell comprises a separator layer, an anode layer, an anode current collector, and a seal. The anode layer is at least partially disposed on the separator layer and has a first surface facing the separator layer, a second surface facing away from the separator layer, and an outer surface extending from the first surface to the second surface. The anode layer comprises a solid-state electrolyte (SSE) having pores. The anode current collector is coupled to the second surface of the anode layer. The seal is disposed on at least a portion of the anode layer and the anode current collector. The seal is substantially impervious to liquid.

In yet another aspect, the present invention provides an anode assembly for a battery cell. The battery cell comprises a separator layer, an anode layer, an anode current collector, and a seal. The anode layer is at least partially disposed on the separator layer and has a first surface facing the separator layer, a second surface facing away from the separator layer, and an outer surface extending from the first surface to the second surface. The anode layer comprises a solid-state electrolyte (SSE) having pores. The anode current collector is coupled to the second surface of the anode layer. The seal is disposed on at least a portion of the anode layer, the separator layer, and the anode current collector. The seal is substantially impervious to liquid.

In another aspect, the present invention provides an anode assembly for a battery cell. The battery cell comprises a separator layer, an anode layer, an anode current collector, and a seal. The anode layer is at least partially disposed on the separator layer and has a first surface facing the separator layer, a second surface facing away from the separator layer, and an outer surface extending from the first surface to the second surface. The anode layer comprises a solid-state electrolyte (SSE) having pores. The anode current collector is coupled to the second surface of the anode layer. The seal comprises a casing that encases the anode layer. The seal is substantially impervious to liquid. In some embodiments, the casing does not contact the anode layer. For example, the casing may be disposed on the outer surface of the anode current collect and/or the separator layer.

### III. MULTI-LAYER ANODE ASSEMBLY

Another aspect of the present invention provides a multi-layer anode assembly. The multi-layer anode assembly combines two anode assemblies described herein such that at least one component is common to each anode assembly. For example, with reference to FIGS. 1B, 3B, 5B, 6B, and 8B, the multi-layer anode assembly may comprise a common anode current collector 106, 306, 506, 606, 806. In some embodiments, the multi-laver anode assembly may comprise a common seal 508, 808, as shown in FIGS. 5B and 8B.

In another aspect, the present invention provides a multi-layer anode assembly. The multi-layer anode assembly comprises a first separator layer, a second separator layer, a first anode layer, a second anode layer, an anode current collector, and a seal. The second separator layer is spaced from the first separator layer. The first anode layer is at least partially disposed on the first separator layer. The first anode layer has a first surface facing the first separator layer, a second surface facing away from the first separator layer, and an outer surface extending from the first surface to the second surface. The first anode layer comprises a SSE having pores. The second anode layer is at least partially disposed on the second separator layer. The second anode layer has a first surface facing the second separator layer, a second surface facing away from the second separator layer, and an outer surface extending from the first surface to the second surface. The second anode layer comprises a SSE having pores. The anode current collector is coupled to the second surfaces of the first and second anode layers. The seal is at least partially disposed on the outer surfaces of the first and second anode layers. The seal comprises a sealant material. And, the seal is substantially impervious to liquid.

In yet another aspect, the present invention provides a multi-layer anode assembly. The multi-layer anode assembly comprises a first separator layer, a second separator layer, a first anode layer, a second anode layer, an anode current collector, a first seal, and a second seal. The second separator layer is spaced from the first separator layer. The first anode layer is at least partially disposed on the first separator layer. The first anode layer has a first surface facing the first separator layer, a second surface facing away from the first separator layer, and an outer surface extending from the first surface to the second surface. The first anode layer comprises a SSE having pores. The second anode layer is at least partially disposed on the second separator layer. The second anode layer has a first surface facing the second separator layer, a second surface facing away from the second separator layer, and an outer surface extending from the first surface to the second surface. The second anode layer comprises a SSE having pores. The anode current collector is coupled to the second surfaces of the first and second anode layers. The first seal is at least partially disposed on the outer surface of the first anode layer. The second seal is at least partially disposed on the outer surface of the second anode layer. The first and second seals comprises a sealant material. And, the first and second seals are substantially impervious to liquid.

### IV. BATTERY CELL

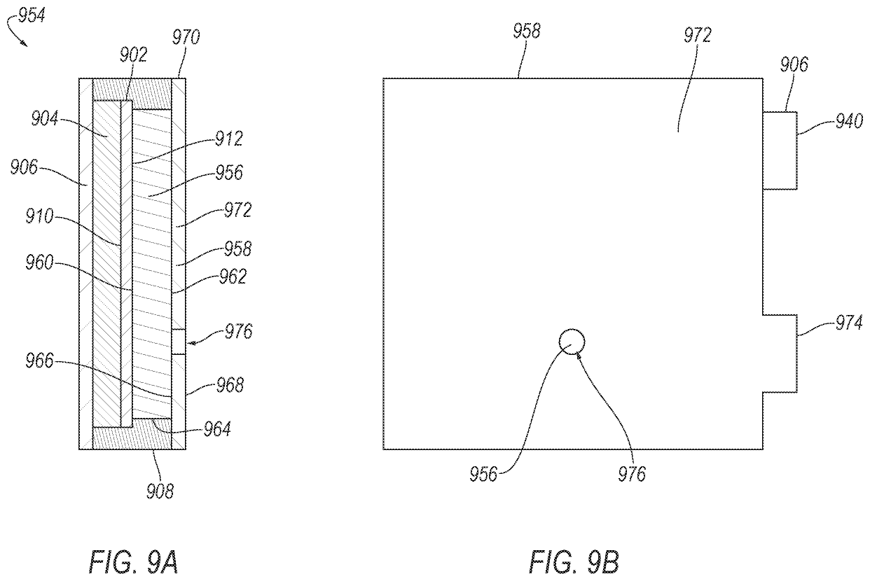

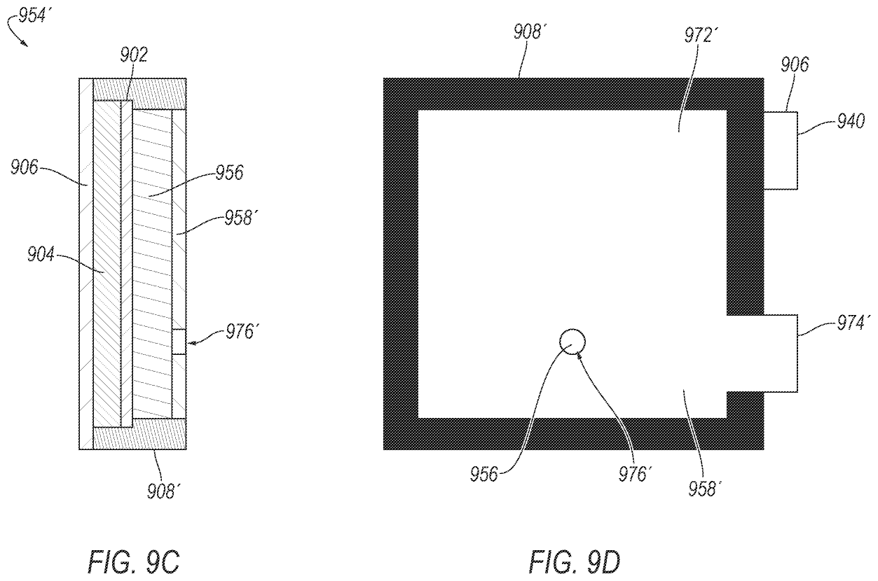

In another aspect, the present invention provides a battery cell. With reference to FIG. 9A, the battery cell 954 comprises a separator layer 902, an anode layer 904, an anode current collector 906, a cathode layer 956, a cathode current collector 958, and a seal 908.

The separator layer may be any separator layer described herein. For example, the separator layer may have a front surface, a back surface spaced form the front surface, and an outer surface extending from the front surface to the back surface.

The anode layer may be any anode layer described herein. For example, the anode layer may be at least partially disposed on the front surface of the separator layer. The anode layer may have a first surface facing the separator layer, a second surface facing away from the separator layer, and an outer surface extending from the first surface to the second surface. And, the anode layer may comprise a SSE having pores.

The anode current collector may be any anode current collector described herein. For example, the anode current collector may be coupled to the second surface of the anode layer.

### A. Cathode Layer

With reference to FIG. 9A, the cathode layer is at least partially disposed on the back surface 912 of the separator layer. The cathode layer has a first surface 960 facing the separator layer, a second surface 962 facing away from the separator layer, and an outer surface 964 extending from the first surface to the second surface.

In some embodiments, the cathode layer is disposed on the entire back surface of the separator layer. In other embodiments, the cathode layer is disposed on substantially all (e.g., at least 60%, at least 70%, at least 80%, at least 90%, or at least 95%) of the back surface of the separator layer. And, in some embodiments, the cathode layer is disposed only on a portion of the back surface of the separator layer.

The cathode layer may be comprised of any suitable material. In some embodiments, the cathode layer comprises a lithium ion-conducting material. For example, the lithium ion-conducting material may be lithium nickel manganese cobalt oxides (NMC, LiNiₓMn_{y}Co_{z}O₂, wherein x+y+2=1), such as LiCoO₂, LiNi_{1/3}Co_{1/3}Mn_{1/3}O₂, LiNi_{0.5}Co_{0.2}Mn_{0.3}O₂; lithium manganese oxides (LMOs), such as LiMn₂O₄, LiNi_{0.5}Mn_{1.5}O₄; lithium iron phosphates (LFPs) such as LiFePO₄, LiMnPO₄, and LiCoPO₄, and Li₂MMn₃O₈, wherein M is selected from Fe, Co, or any combination thereof. In some embodiments, the ion-conducting cathode material is a high energy ion-conducting cathode material such as Li₂MMn₃O₈, wherein M is selected from Fe, Co, or any combination thereof.

In some embodiments, the cathode comprises a sodium ion-conducting material. For example, the sodium ion-conducting material may be Na₂V₂O₅, P2-Na_{2/3}Fe_{1/2}Mn_{1/2}O₂, Na₃V₂(PO₄)₃, NaMn_{1/3}Co_{1/3}Ni_{1/3}PO₄, or any composite material (e.g., composites with carbon black) thereof (e.g., Na_{2/3}Fe_{1/2}Mn_{1/2}O₂@graphene composite).

In some embodiments, the cathode layer comprises a magnesium ion-conducting material. For example, the magnesium ion-conducting material may be doped manganese oxide (e.g., MgₓMnO_{2·y}H₂O).

In some embodiments, the cathode layer comprises an organic sulfide or a polysulfide. For example, the organic sulfide or polysulfide may be carbynepolysulfide and copolymerized sulfur.

In some embodiments, the cathode layer comprises an air electrode. For example, the air electrode may be large surface area carbon particles (e.g., Super P (i.e., a conductive carbon black)) and catalyst particles (e.g., alpha-MnO₂ nanorods) bound in a mesh (e.g., a polymer binder such as PVDF binder).

In some embodiments, the battery cell further comprises a catholyte (e.g., a liquid catholyte) disposed in the cathode layer. In such embodiments, the seal is substantially impervious to the cathode layer. The catholyte may comprise any material suitable for promoting liquid-solid contact and/or providing an improved interface for ion transfer. For example, the catholyte may comprise comprises a lithium salt, a linear carbonate, a cyclic carbonate, an ionic liquid, or any combination thereof. For example, the catholyte may comprise a mixture of lithium bis(fluorosulfonyl)imide and N-propyl-N-methylpyrrolidinium bis(fluorosulfonyl)imide. In other embodiments, the catholyte comprises or a mixture of lithium hexafluorophosphate, ethylene carbonate, and ethyl methyl carbonate.

In some embodiments, the cathode layer has a thickness of from about 1 μm to about 500 μm. In some embodiments, the cathode layer has a thickness of from about 1 μm to about 200 μm. In other embodiments, the cathode layer has a thickness of from about 1 μm to about 100 μm. In some embodiments, the cathode layer has a thickness of from about 1 μm to about 50 μm. In some embodiments, the cathode layer has a thickness of from about 1 μm to about 20 μm. In some embodiments, the cathode layer has a thickness of from about 10 μm to about 150 μm. In other embodiments, the cathode layer has a thickness of from about 40 μm to about 100 μm. And, in some embodiments, the cathode layer has a thickness of from about 60 μm to about 80 μm.

### B. Cathode Current Collector

The cathode current collector is coupled to the cathode layer. With reference again to FIG. 9A the cathode current collector is coupled to the second surface of the cathode layer. In some embodiments, the cathode current collector has an interior surface 966 facing the cathode layer, an exterior surface 968 facing away from the cathode layer, and an outer surface 970 extending from the interior surface to the exterior surface.

In some embodiments, the cathode current collector is at least partially disposed on the second surface of the cathode layer. In some embodiments, the cathode current collector is disposed on the entire second surface of the cathode layer. In other embodiments, the cathode current collector is disposed on substantially all (e.g., at least 60%, at least 70%, at least 80%, at least 90%, or at least 95%) of the second surface of the cathode layer. And, in other embodiments, the cathode current collector is disposed only on a portion of the second surface of the cathode layer.

In some embodiments, the cathode current collector comprises a metal foil 972, as shown in FIGS. 9A and 9B. In such embodiments, the metal foil is at least partially disposed on the second surface of the cathode layer. In some embodiments, the metal foil is disposed on the entire second surface of the cathode layer. In other embodiments, the metal foil is disposed on substantially all (e.g., at least 60%, at least 70%, at least 80%, at least 90%, or at least 95%) of the second surface of the cathode layer. And, in other embodiments, the metal foil is disposed only on a portion of the second surface of the cathode layer.

In some embodiments, the metal foil has a tab 974 configured to connect with an external circuit, as shown in FIG. 9B. In the illustrated embodiment, the tab is integral with the metal foil. In other embodiments, the tab is coupled (e.g., welded) to the metal foil.

The cathode current collector may be comprised of any suitable material. In some embodiments, the cathode current collector (e.g., the metal foil and/or the tab) comprises aluminum, stainless steel, alloys thereof, or any combination thereof. In some embodiments, the cathode current collector comprises aluminum. In some embodiments, the cathode current collector comprises an aluminum alloy. In other embodiments, the cathode current collector comprises stainless steel. And, in some embodiments, the cathode current collector comprises a stainless steel alloy.

In some embodiments, the cathode current collector comprises an electronically conductive film. For example, the electronically conductive film may comprise a polymer material and a conductive material. For example, the conductive material may be a metal material. In some embodiments, the conductive material comprises aluminum, stainless steel, alloys thereof, or any combination thereof.

In some embodiments, electronically conductive tape couples the cathode current collector to the cathode layer. During operation of the battery cell (e.g., charging and/or discharging of the battery cell), the electronically conductive tape may electrically couple the cathode current collector to the cathode layer.

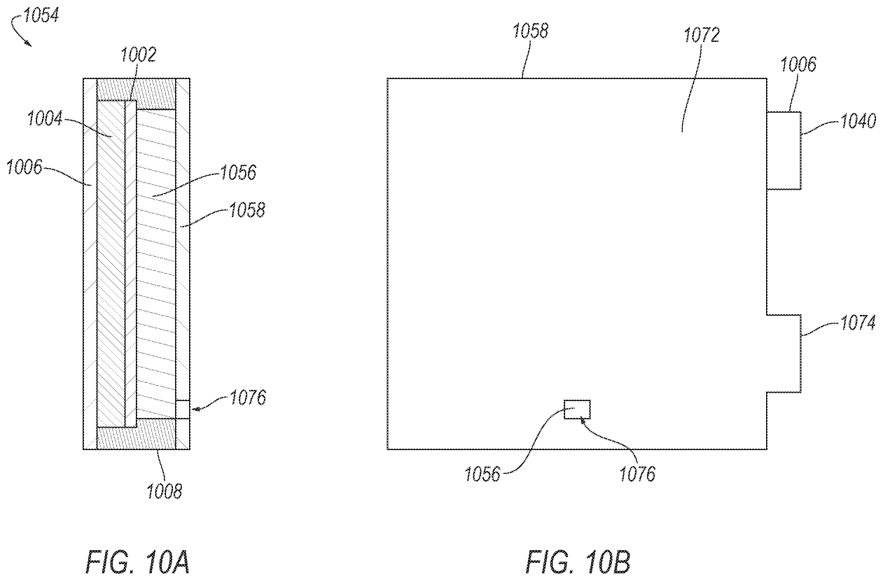

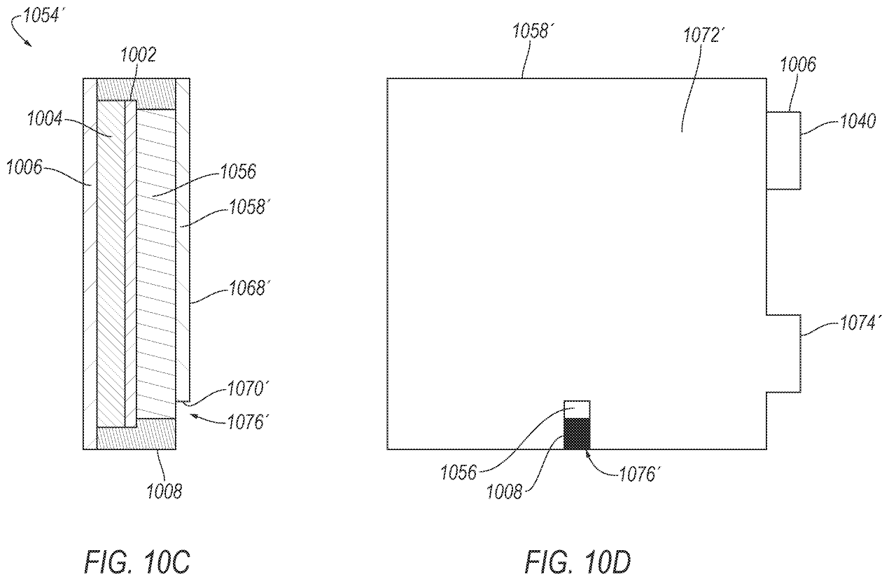

In some embodiments, the cathode current collector defines an aperture 976 configured to permit filling of the cathode layer with a catholyte, as shown in FIGS. 9A and 9B. In the illustrated embodiment, the exterior surface of the cathode current collector defines the aperture configured to permit filling of the cathode layer with a catholyte. In other embodiments, the outer surface and the exterior surface of the cathode current collector define the aperture 1076′ configured to permit filling of the cathode layer with a catholyte, as shown in FIGS. 10C and 10D.

In some embodiments, a cross-sectional width of the cathode current collector is greater than a cross-sectional width of the cathode layer, as shown in FIGS. 7A, 9A, and 10A. In other embodiments, a cross-sectional width of the cathode current collector is substantially the same as a cross-sectional width of the cathode layer, as shown in FIGS. 7C and 9C.

### C. Seal

The seal comprises a sealant material. The seal is substantially impervious to liquid. The seal may be any seal described herein.

In some embodiments, the seal is pervious to gas. In some embodiments, the seal is at least partially disposed on the outer surface of the anode layer.

In some embodiments, the seal is at least partially disposed on the cathode layer. For example, the seal may be at least partially disposed on the outer surface of the cathode layer, as shown in FIGS. 9A, 9C, 10A, and 10C. In the illustrated embodiments, the seal is disposed on the entire outer surface of the cathode layer. In other embodiments, the seal is disposed on substantially all (e.g., at least 60%, at least 70%, at least 80%, at least 90%, or at least 95%) of the outer surface of the cathode layer. And, in some embodiments, the seal is disposed only on a portion of the outer surface of the cathode layer.

In some embodiments, the seal is at least partially disposed on the cathode current collector. For example, the seal may be at least partially disposed on the outer surface of the cathode current collector, as shown in FIGS. 9C and 10C. In other embodiments, the seal is disposed on substantially all (e.g., at least 60%, at least 70%, at least 80%, at least 90%, or at least 95%) of the outer surface of the cathode current collector. And, in some embodiments, the seal is disposed only on a portion of the outer surface of the cathode current collector.

In some embodiments, the seal is at least partially disposed on the interior surface of the cathode current collector, as shown in FIGS. 9A and 10A. In other embodiments, the seal is disposed on substantially all (e.g., at least 60%, at least 70%, at least 80%, at least 90%, or at least 95%) of the interior surface of the cathode current collector. And, in some embodiments, the seal is disposed only on a portion of the interior surface of the cathode current collector, as shown in FIGS. 9A and 10A.

In some embodiments, the seal is at least partially disposed on each of the outer surface of the anode layer, the outer surface of the separator layer, and the interior surfaces of the anode and cathode current collectors. For example, the seal may be disposed on the entire outer surface of the anode layer, the entire outer surface of the separator layer, and only a portion the interior surfaces of the anode current collector and the cathode current collector, as shown in FIGS. 9A and 10A.

In some embodiments, the seal may be at least partially disposed on each of the outer surface of the anode layer, the outer surface of the separator layer, the interior surface of the cathode current collector, and the outer and exterior surfaces of the anode current collector, as shown in FIG. 7A. In the illustrated embodiment, the seal is disposed on the entire outer surface of the anode layer, the entire outer surface of the separator layer, only a portion of the interior surface of the cathode current collector, and the entire outer and exterior surfaces of the anode current collector.

In some embodiments, the seal is at least partially disposed on each of the outer surface of the anode layer, the outer surface of the separator layer, the outer surface of the cathode layer, and the interior surfaces of the anode and cathode current collectors. For example, the seal may be disposed on the entire outer surface of the anode layer, the entire outer surface of the separator layer, the entire outer surface of the cathode layer, and only a portion the interior surfaces of the anode current collector and the cathode current collector, as shown in FIGS. 9A and 10A.

In some embodiments, the seal may be at least partially disposed on each of the outer surface of the anode layer, the outer surface of the separator layer, the outer surface of the cathode layer, the interior surface of the cathode current collector, and the outer and exterior surfaces of the anode current collector. For example, the seal may be disposed on the entire outer surface of the anode layer, the entire outer surface of the separator layer, the entire outer surface of the cathode layer, only a portion of the interior surface of the cathode current collector, and the entire outer and exterior surfaces of the anode current collector, as shown in FIG. 7A.

In some embodiments, the seal may be at least partially disposed on each of the outer surface of the anode layer, the outer surface of the separator layer, the outer surface of the cathode layer, the outer surface of the cathode current collector, and the outer and exterior surfaces of the anode current collector, as shown in FIG. 7C. In the illustrated embodiment, the seal is disposed on the entire outer surface of the anode layer, the entire outer surface of the separator layer, the entire outer surface of the cathode layer, the entire outer surface of the cathode current collector, and the entire outer and exterior surfaces of the anode current collector.

In some embodiments, the seal may be at least partially disposed on each of the outer surface of the anode layer, the outer surface of the separator layer, the outer surface of the cathode layer, the outer surface of the cathode current collector, and the interior surface of the anode current collector. For example, the seal may be disposed on the entire outer surface of the anode layer, the entire outer surface of the separator layer, the entire outer surface of the cathode layer, the entire outer surface of the cathode current collector, and only a portion of the interior surface of the anode current collector, as shown in FIG. 9C.

In some embodiments, the seal is at least partially disposed on the anode layer and the separator layer. In other embodiments, the seal is at least partially disposed on the anode layer and the anode current collector. And, in some embodiments, the seal is at least partially disposed on the anode layer, the anode current collector, and the separator layer.

The sealant material may be any sealant material described herein. In some embodiments, the sealant material comprises polypropylene, polyethylene, polyimide, polyvinyl chloride (PVC), ethylene-vinyl acetate, polyamide, polypropylene, polyurethane, copolymers thereof, or any combination thereof. For example, the sealant material may comprise polypropylene. In some embodiments, the sealant material comprises polyethylene. In other embodiments, the sealant material comprises polyimide. In some embodiments, the sealant material comprises PVC. In some embodiments, the sealant material comprises ethylene-vinyl acetate. In other embodiments, the sealant material comprises polyamide. In some embodiments, the sealant material comprises polypropylene. And, in some embodiments, the sealant material comprises polyurethane.

In some embodiments, the sealant material comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof. In some embodiments, the sealant material comprises polypropylene. In some embodiments, the sealant material comprises polyethylene. In other embodiments, the sealant material comprises polymethylpentene. In some embodiments, the sealant material comprises polybutene-1. In some embodiments, the sealant material comprises ethylene-octene copolymers. In some embodiments, the sealant material comprises propylene-butane copolymers. In some embodiments, the sealant material comprises polyisobutylene. In some embodiments, the sealant material comprises poly(α-olefin). In some embodiments, the sealant material comprises ethylene propylene rubber. In other embodiments, the sealant material comprises ethylene propylene diene monomer rubber. In some embodiments, the sealant material comprises ethylene-vinyl acetate. In some embodiments, the sealant material comprises ethylene-acrylate copolymers. In other embodiments, the sealant material comprises polyamides. In some embodiments, the sealant material comprises polyesters. In some embodiments, the sealant material comprises polyurethanes. In some embodiments, the sealant material comprises styrene block copolymers. In some embodiments, the sealant material comprises polycaprolactone. In other embodiments, the sealant material comprises polyimide. In some embodiments, the sealant material comprises polyvinyl chloride. In some embodiments, the sealant material comprises polycarbonates. In some embodiments, the sealant material comprises polyacrylates. In some embodiments, the sealant material comprises polymethacrylates. In some embodiments, the sealant material comprises fluoropolymers. In some embodiments, the sealant material comprises epoxy resins. In other embodiments, the sealant material comprises epoxy polymers. And, in some embodiments, the sealant material comprises silicone rubber.

In some embodiments, at least a portion of the seal has a thickness of from about 1 μm to about 50 μm. In some embodiments, at least a portion of the seal has a thickness of from about 1 μm to about 20 μm. In other embodiments, at least a portion of the seal has a thickness of from about 1 μm to about 10 μm. And, in some embodiments, at least a portion of the seal has a thickness of from about 1 μm to about 5 μm.

### D. Housing

In some embodiments, the battery cell further comprises a housing. The housing may be any housing described herein. For example, the housing may comprise a plurality of interior walls defining an interior. The separator layer, the anode layer, the anode current collector, the cathode layer, the cathode current collector, and the seal may be disposed in the interior of the housing.

### V. ELECTRODE PAIR ASSEMBLY

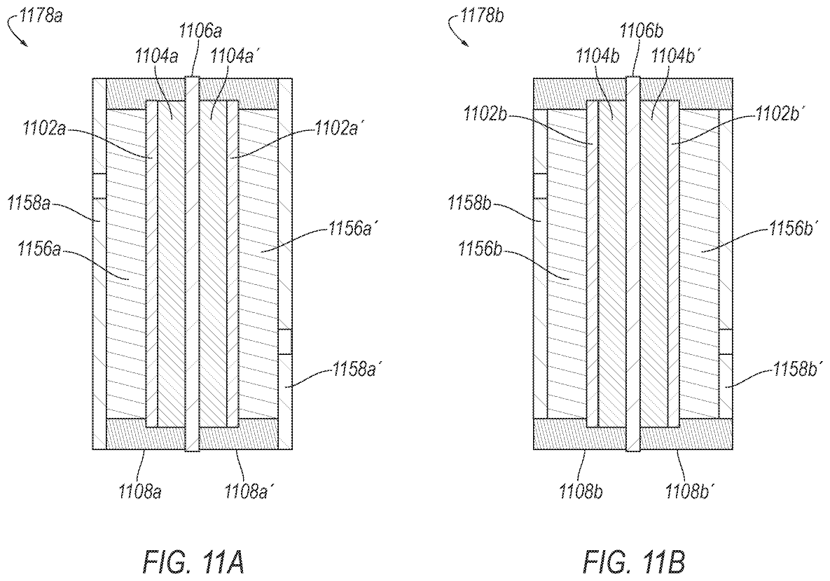

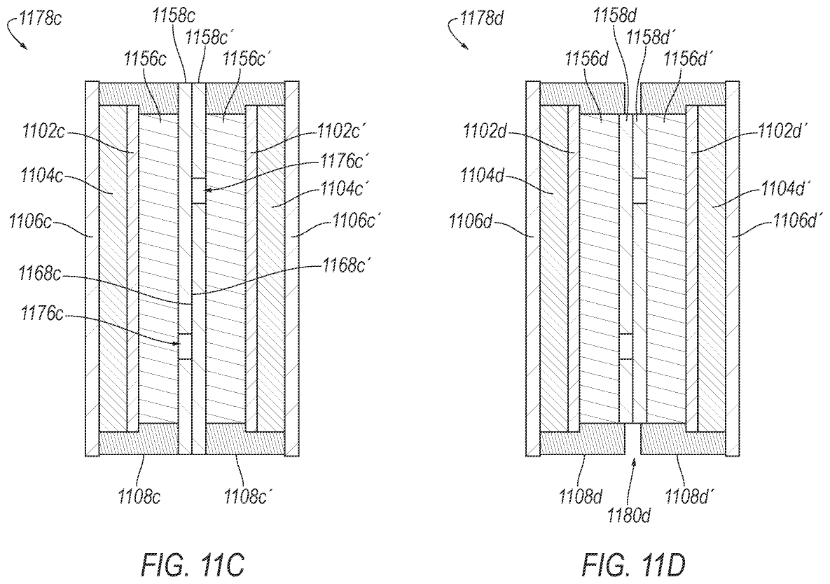

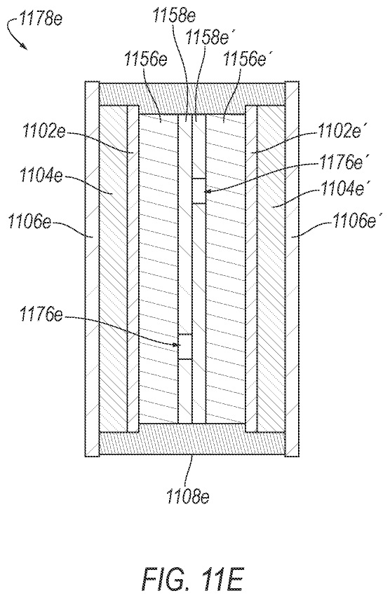

In another aspect, the present invention provides an electrode pair assembly. With reference to FIG. 11A, the electrode pair assembly 1178a comprises a first separator layer 1102a, a first anode layer 1104a, a first anode current collector 1106a, a first cathode layer 1156a, a first cathode current collector 1158a, and a first seal 1108a. The electrode pair assembly further comprises a second separator layer 1102a′, a second anode layer 1104a′, and a second cathode layer 1156a′.

The first and second separator layers may each be any separator layer described herein. In some embodiments, the first and second separator layers are different. In other embodiments, the first and second separator layers are the same.

The first and second anode layers may each be any anode layer described herein. In some embodiments, the first and second anode layers are different. In other embodiments, the first and second anode layers are the same.

The first and second cathode layers may each be any cathode layer described herein. In some embodiments, the first and second cathode layers are different. In other embodiments, the first and second cathode layers are the same.

The first anode current collector may be any anode current collector described herein. In some embodiments, the first anode current collector 1106a, 1106b serves as a common current collector for the first and second anode layers, as shown in FIGS. 11A and 11B. In other embodiments, the electrode pair assembly further comprises a second anode current collector 1106c′, 1106d′, as shown in FIGS. 11C and 11D. The second anode current collector may be any anode current collector described herein. In some embodiments, the first and second anode current collectors are different. In other embodiments, the first and second anode current collectors are the same.

The first cathode current collector may be any cathode current collector described herein. In some embodiments, the first cathode current collector serves as a common current collector for the first and second cathode layers. In other embodiments, the electrode pair assembly further comprises a second cathode current collector 1158a′, 1158b′, 1158c′, 1158d′, as shown in FIGS. 11A, 11B, 11C, and 11D. The second cathode current collector may be any cathode current collector described herein. In some embodiments, the first and second cathode current collectors are different. In other embodiments, the first and second cathode current collectors are the same.

In some embodiments, the exterior surface 1168c of the first cathode current collector is disposed on the exterior surface 1168c′ of the second cathode current collector, as Shown in FIG. 11C.

With continued reference to FIG. 11C, when the first and second cathode current collectors define apertures 1176c, 1176c′ configured to permit filling of the first and second cathode layers with a catholyte, the apertures may be spaced from each other such that the aperture of the first cathode current collector is sealed by the second cathode current collector and the aperture of the second cathode current collector is sealed by the first cathode current collector. In other embodiments, the apertures 1276b, 1276b′ may be substantially aligned such that the first and second cathode layers are in fluid communication with each other, as shown in FIG. 12B.

The first seal may be any seal described herein. In some embodiments, the first seal 1108e serves as a common seal for at least the first and second anode layers (e.g., the first seal is at least partially disposed on the outer surfaces of the first and second anode layers), as shown in FIG. 11E. In other embodiments, the electrode pair assembly further comprises a second seal 1108a′, as shown in FIG. 11A. The second seal may be any seal described herein. In some embodiments, the first and second seals are different. In other embodiments, the first and second seals are the same.

With reference to FIG. 11A, the electrode pair assembly 1178a may comprise the first separator layer 1102a, the second separator layer 1102a′, the first anode layer 1104a, the second anode layer 1104a′, the first cathode layer 1156a, the second cathode layer 1156a′, the first anode current collector 1106a, the first cathode current collector 1158a, the second cathode current collector 1158a′, the first seal 1108a, and the second seal 1108a′. The first anode current collector is a common current collector for the first and second anode layers. The first seal is at least partially disposed on each of the outer surface of the first anode layer, the outer surface of the first separator layer, the back surface of the first separator layer, the outer surface of the first cathode layer, the interior surface of the first cathode current collector, and the interior surface of the first anode current collector. The second seal is at least partially disposed on each of the outer surface of the second anode layer, the outer surface of the second separator layer, the back surface of the second separator layer, the outer surface of the second cathode layer, the interior surface of the second cathode current collector, and the exterior surface of the first anode current collector.

With reference to FIG. 11B, the electrode pair assembly 1178b differs from the electrode pair assembly 1176a of FIG. 11A in that the first seal 1108b and the second seal 1108b′ are at least partially disposed on the outer surfaces of the first and second cathode current collectors 1158b, 1158b′, respectively, instead of the interior surfaces of the first and second cathode current collectors. A cross-sectional width of the first and second cathode current collectors is substantially the same as a cross-sectional width of the first and second cathode layers.

With reference to FIG. 11C, the electrode pair assembly 1178c may comprise the first separator layer 1102c, the second separator layer 1102c′, the first anode layer 1104c, the second anode layer 1104c′, the first cathode layer 1156, the second cathode layer 1156c′, the first anode current collector 1106c, the second anode current collector 1106c′, the first cathode current collector 1158c, the second cathode current collector 1158c′, the first seal 1108c, and the second seal 1108c′. The first seal is at least partially disposed on each of the outer surface of the first anode layer, the outer surface of the first separator layer, the back surface of the first separator layer, the outer surface of the first cathode layer, the interior surface of the first cathode current collector, and the interior surface of the first anode current collector. The second seal is at least partially disposed on each of the outer surface of the second anode layer, the outer surface of the second separator layer, the back surface of the second separator layer, the outer surface of the second cathode layer, the interior surface of the second cathode current collector, and the interior surface of the second anode current collector. The exterior surface of the first cathode current collector is disposed on the exterior surface of the second cathode current collector. The first and second current collectors each define apertures 1176c, 1176c′. The apertures are spaced from each other such that the aperture of the first cathode current collector is sealed by the second cathode current collector and the aperture of the second cathode current collector is sealed by the first cathode current collector. Thus, the first and second cathode layers may each be filled with a catholyte prior to assembly of the electrode pair assembly.

With reference to FIG. 11D, the electrode pair assembly 1178d differs from the electrode pair assembly 1178c of FIG. 11C in that the first seal 1108d and the second seal 1108d′ are at least partially disposed on the outer surfaces of the first and second cathode current collectors 1158d, 1158d′, respectively, instead of the interior surfaces of the first and second cathode current collectors. A cross-sectional width of the first and second cathode current collectors is substantially the same as a cross-sectional width of the first and second cathode layers. The first and second seal define a gap 1180d. The gap may allow for filling of the first and second cathode layers with a catholyte after assembly of the electrode pair assembly.

With reference to FIG. 11E, the electrode pair assembly 1178e differs from the electrode pair assembly 1178d of FIG. 11D in that the electrode pair assembly 1178e comprises only a first seal 1108e and not a second seal. The first seal is at least partially disposed on each of the outer surface of the first anode layer, the outer surface of the first separator layer, the back surface of the first separator layer, the outer surface of the first cathode layer, the outer surface of the first cathode current collector, the interior surface of the first anode current collector, the outer surface of the second anode layer, the outer surface of the second separator layer, the back surface of the second separator layer, the outer surface of the second cathode layer, the outer surface of the second cathode current collector, and the interior surface of the second anode current collector.

With reference to FIG. 12A, the electrode pair assembly 1278a may comprise the first separator layer 1202a, the second separator layer 1202a′, the first anode layer 1204a, the second anode layer 1204a′, the first cathode layer 1256a, the second cathode layer 1256a′, the first anode current collector 1206a, the first cathode current collector 1258a, the second cathode current collector 1258a′, the first seal 1208a, and the second seal 1208a′. The first anode current collector is a common current collector for the first and second anode layers. The first seal is at least partially disposed on each of the outer surface of the first anode layer, the outer surface of the first separator layer, the back surface of the first separator layer, the outer surface of the first cathode layer, the interior surface of the first cathode current collector, and the interior surface of the first anode current collector. The second seal is at least partially disposed on each of the outer surface of the second anode layer, the outer surface of the second separator layer, the back surface of the second separator layer, the outer surface of the second cathode layer, the interior surface of the second cathode current collector, and the exterior surface of the first anode current collector. The first and second current collectors each define apertures.

With reference to FIG. 12C, the electrode pair assembly 1278c differs from the electrode pair assembly 1278a of FIG. 12A in that the exterior and outer surfaces of the first and second cathode current collectors 1258c, 1258c′ define each aperture 1276c, 1276c′ instead of only the exterior surfaces of the first and second cathode current collectors.

With reference to FIG. 12B, the electrode pair assembly 1278B may comprise the first separator layer 1202b, the second separator layer 1202b′, the first anode layer 1204b, the second anode layer 1204b′, the first cathode layer 1256b, the second cathode layer 1256b′, the first anode current collector 1206b, the second anode current collector 1206b′, the first cathode current collector 1258b, the second cathode current collector 1258b′, the first seal 1208b, and the second seal 1208b′. The first seal is at least partially disposed on each of the outer surface of the first anode layer, the outer surface of the first separator layer, the back surface of the first separator layer, the outer surface of the first cathode layer, the interior surface of the first cathode current collector, and the interior surface of the first anode current collector. The second seal is at least partially disposed on each of the outer surface of the second anode layer, the outer surface of the second separator layer, the back surface of the second separator layer, the outer surface of the second cathode layer, the interior surface of the second cathode current collector, and the interior surface of the second anode current collector. The exterior surface of the first cathode current collector is disposed on the exterior surface of the second cathode current collector. The first and second current collectors each define apertures 1276b, 1276b′. The apertures are substantially aligned such that the first and second cathode layers are in fluid communication with each other.

With reference to FIG. 12D, the electrode pair assembly 1278d differs from the electrode pair assembly 1278b of FIG. 12B in that the exterior and outer surfaces of the first and second cathode current collectors 1258d, 1258d′ define each aperture 1276d, 1276d′ instead of only the exterior surfaces of the first and second cathode current collectors.

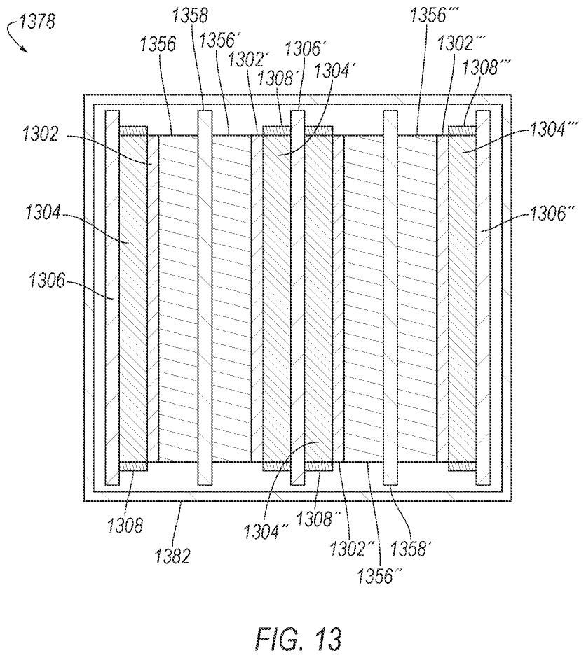

With reference to FIG. 13, the electrode pair assembly 1378 may comprise the first anode current collector 1306, the first anode layer 1304, the first seal 1308, the first separator layer 1302, the first cathode layer 1356, the first cathode current collector 1358, the second cathode layer 1356′, the second separator layer 1302′, the second anode layer 1304′, the second seal 1308′, the second anode current collector 1306′, the third anode layer 1304″, the third seal 1308″, third separator layer 1302″, the third cathode layer 1356″, the second cathode current collector 1358′, the fourth cathode layer 1356″, the fourth separator layer 1302″, the fourth anode layer 1304″, the fourth seal 1308′″, and the third anode current collector 1306″. The first cathode current collector is a common current collector for the first and second cathode layers. The second anode current collector is a common current collector for the second and third cathode layers. The second cathode current collector is a common current collector for the third and fourth cathode layers. The first seal is at least partially disposed on the outer surface of the first anode layer. The second seal is at least partially disposed on the outer surface of the second anode layer. The third seal is at least partially disposed on the outer surface of the third anode layer. The fourth seal is at least partially disposed on the outer surface of the fourth anode layer. The electrode pair assembly may be disposed in a housing 1382.

### VI. METHODS OF FORMING AN ANODE ASSEMBLY

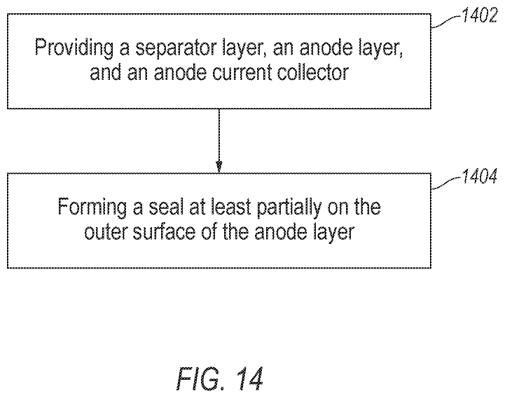

Another aspect of the present invention provides a method of forming an anode assembly. With reference to FIG. 14, a flow chart depicting an exemplary implementation of forming an anode assembly for a battery cell is provided. The method comprises
(a) providing:
   a separator layer,
   an anode layer at least partially disposed on the separator layer and having a first surface facing the separator layer, a second surface facing away from the separator layer, and an outer surface extending from the first surface to the second surface, wherein the anode layer comprises a solid-state electrolyte (SSE) having pores, and
   an anode current collector coupled the second surface of the anode layer (1402); and
(b) forming a seal at least partially on the outer surface of the anode layer, wherein the seal is substantially impervious to liquid (1404).

The separator layer may be any separator layer described herein. The anode layer may be any anode layer described herein. The anode current collector may be any anode current collector described herein.

In some implementations, the forming of step (b) comprises forming the seal from a sealant material by cold-pressing, hot-pressing, melting, 3D-printing, or any combination thereof, the sealant material at least partially on the outer surface of the anode layer. In some implementations, the forming of step (b) comprises forming the seal from a sealant material by cold-pressing the sealant material at least partially on the outer surface of the anode layer. In other implementations, the forming of step (b) comprises forming the seal from a sealant material by hot-pressing the sealant material at least partially on the outer surface of the anode layer. In some implementations, the forming of step (b) comprises forming the seal from a sealant material by melting the sealant material at least partially on the outer surface of the anode layer. And, in some implementations, the forming of step (b) comprises forming the seal from a sealant material by 3D-printing the sealant material at least partially on the outer surface of the anode layer.

In some implementations, the forming of step (b) comprises forming the seal from a sealant material by mechanically applying the sealant material at least partially on the outer surface of the anode layer. For example, the forming of step (b) may comprise forming the seal from a sealant material by applying the sealant material at least partially on the outer surface of the anode layer with a paintbrush, a roller, a plastic applicator, a metal applicator, a shaping tool, a syringe dispenser, a dispenser valve, or any combination thereof. In some implementations, the forming of step (b) comprises forming the seal from a sealant material by applying the sealant material at least partially on the outer surface of the anode layer with a paintbrush. In other implementations, the forming of step (b) comprises forming the seal from a sealant material by applying the sealant material at least partially on the outer surface of the anode layer with a roller. In some implementations, the forming of step (b) comprises forming the seal from a sealant material by applying the sealant material at least partially on the outer surface of the anode layer with a plastic applicator. In some implementations, the forming of step (b) comprises forming the seal from a sealant material by applying the sealant material at least partially on the outer surface of the anode layer with a metal applicator. In other implementations, the forming of step (b) comprises forming the seal from a sealant material by applying the sealant material at least partially on the outer surface of the anode layer with a shaping tool. In some implementations, the forming of step (b) comprises forming the seal from a sealant material by applying the sealant material at least partially on the outer surface of the anode layer with a syringe dispenser. And, in some implementations, the forming of step (b) comprises forming the seal from a sealant material by applying the sealant material at least partially on the outer surface of the anode layer with a dispenser valve.

In some implementations, the forming of step (b) comprises forming the seal from a sealant material by injection molding, in-line extrusion, spray deposition, 3D-printing, wrapping, or any combination thereof, the sealant material at least partially on the outer surface of the anode layer. In some implementations, the forming of step (b) comprises forming the seal from a sealant material by injection molding the sealant material at least partially on the outer surface of the anode layer. In other implementations, the forming of step (b) comprises forming the seal from a sealant material by in-line extrusion of the sealant material at least partially on the outer surface of the anode layer. In some implementations, the forming of step (b) comprises forming the seal from a sealant material by spray deposition of the sealant material at least partially on the outer surface of the anode layer. In some implementations, the forming of step (b) comprises forming the seal from a sealant material by 3D-printing of the sealant material at least partially on the outer surface of the anode layer. And, in some implementations, the forming of step (b) comprises forming the seal from a sealant material by wrapping the sealant material at least partially on the outer surface of the anode layer.

The temperature and/or application pressure of the sealant material may be selected to provide suitable sealant material flow and coverage, without damage to the other components of the anode assembly. In implementations where the sealant material is at least partially disposed on the outer surface of the anode layer and in the pores of the second porous region, the temperature and/or application pressure of the sealant material may be sufficient to allow for the desired level of infiltration of the pores of the second porous region. Likewise, the location of the sealant material, volume of the sealant material, and rate of application the sealant material, as well as any cooling regime for the seal, may be adjusted for each particular embodiment of the seal.

The sealant material may be any sealant material described herein. For example, the sealant material may comprise polypropylene, polyethylene, polyimide, polyvinyl chloride (PVC), ethylene-vinyl acetate, polyamide, polypropylene, polyurethane, copolymers thereof, or any combination thereof. For example, the sealant material may comprise polypropylene. In some implementations, the sealant material comprises polyethylene. In other implementations, the sealant material comprises polyimide. In some implementations, the sealant material comprises PVC. In some implementations, the sealant material comprises ethylene-vinyl acetate. In other implementations, the sealant material comprises polyamide. In some implementations, the sealant material comprises polypropylene. And, in some implementations, the sealant material comprises polyurethane.

In some implementations, the sealant material comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof. In some implementations, the sealant material comprises polypropylene. In some implementations, the sealant material comprises polyethylene. In other implementations, the sealant material comprises polymethylpentene. In some implementations, the sealant material comprises polybutene-1. In some implementations, the sealant material comprises ethylene-octene copolymers. In some implementations, the sealant material comprises propylene-butane copolymers. In some implementations, the sealant material comprises polyisobutylene. In some implementations, the sealant material comprises poly(α-olefin). In some implementations, the sealant material comprises ethylene propylene rubber. In other implementations, the sealant material comprises ethylene propylene diene monomer rubber. In some implementations, the sealant material comprises ethylene-vinyl acetate. In some implementations, the sealant material comprises ethylene-acrylate copolymers. In other implementations, the sealant material comprises polyamides. In some implementations, the sealant material comprises polyesters. In some implementations, the sealant material comprises polyurethanes. In some implementations, the sealant material comprises styrene block copolymers. In some implementations, the sealant material comprises polycaprolactone. In other implementations, the sealant material comprises polyimide. In some implementations, the sealant material comprises polyvinyl chloride. In some implementations, the sealant material comprises polycarbonates. In some implementations, the sealant material comprises polyacrylates. In some implementations, the sealant material comprises polymethacrylates. In some implementations, the sealant material comprises fluoropolymers. In some implementations, the sealant material comprises epoxy resins. In other implementations, the sealant material comprises epoxy polymers. And, in some implementations, the sealant material comprises silicone rubber.

In some implementations, the forming of step (b) further comprises curing the sealant material. For example, curing the sealant material may comprise curing the sealant material by exposure to radiation (e.g., ultraviolet (UV) radiation). In some implementations, curing may be performed with UV radiation from a UV lamp. In other implementations, curing the sealant material comprises epoxy curing.

In another aspect, the present invention provides a method of forming an anode assembly. The method comprises
(a-1) providing:
   a separator layer,
   an anode layer at least partially disposed on the separator layer and having a first surface facing the separator layer, a second surface facing away from the separator layer, and an outer surface extending from the first surface to the second surface, wherein the anode layer comprises a solid-state electrolyte (SSE) having pores, and
   an anode current collector coupled to the second surface of the anode layer; and
(b-2) forming a seal at least partially on the outer surface of the anode layer, wherein the seal is substantially impervious to liquid.

### VII. EXAMPLES

In order that the invention described herein may be more fully understood, the following examples are set forth. The examples described in this application are offered to illustrate the methods and anode assemblies provided herein and are not to be construed in any way as limiting their scope.

### Example 1: Epoxy Seal

In a fume hood at ambient pressure and room temperature, a 5 mL mixing syringe was attached to the end of an epoxy gun (Nordson TAH manual dispensing gun or a 3M dual cartridge dispensing gun). The plunger was removed from the 5 mL syringe and a 20-gauge blunt tip needle was attached via the luer lock connection. Using the epoxy gun with the mixing syringe attached, 1-3 mL of epoxy was filled directly into the 5 ml syringe (T=0) minutes (mins)). The plunger back was added into the syringe to expel any air remaining in the syringe. At T=30 mins, an epoxy type material (Hysol E 120 HP available from Henkel Corporation (Rocky Hill, Connecticut)) was brought into the glove box using the small vacuum antechamber by pulling vacuum for 1.5 mins and refilling the chamber (repeated for three (3) cycles).

An anode assembly was provided. The anode assembly comprised a 1 cm by 1 cm ceramic bilayer with a metallized current collecting layer disposed on the face of the porous (i.e., anode) layer opposite the dense (i.e., separator) layer. The metallized current collecting layer was adhered to an anode current collector using an electronically conductive adhesive material.

The porous (i.e., anode) layer was oriented downwards on the work surface. At T=60 mins, the syringe was used to apply a layer of epoxy around the edge of the anode assembly while holding the assembly with tweezers. The layer of epoxy was applied to ensure that there was an amount of epoxy overlapping the surface of the dense (i.e., separator) layer of the ceramic bilayer on sides perpendicular to the plane of electrode pairs (i.e., outer surfaces of the anode layer and the separator layer). Additional epoxy was applied in any locations where gaps and/or bubbles formed. The epoxy was dispensed slowly and deliberately to avoid bubble formation. Once the seal deposition (i.e., epoxy layer) was completed, the anode assemblies were suspended using binder clips attached to a ring stand to prevent the assemblies from curing to any surfaces. The appropriate epoxy cure schedule was followed. The cure schedule was 20 hours at room temperature.

### Example 2: Polyethylene (LDPE) Seal

A hot plate was lined with a clean sheet of aluminum foil. The aluminum foil was pressed such that it formed to the hot plate so there was only a minimal gap between the hot plate surface and the aluminum foil.

Using tweezers, thin film LDPE strips were placed in a square around the anode assembly (i.e., an anode assembly substantially similar to the anode assembly of Example 1 above). The strips overlapped the surface of the ceramic bilayer by 0.5-1.5 mm and extended to the anode current collector. Once the LDPE strips were in place, the hot plate was heated to 150° C. The LDPE strips were allowed to fully melt. After the LDPE strips were melted, any observable gaps were filled with additional LDPE strips that were also allowed to melt. Using a cool glass slide (maintained at room temperature), pressure was gently applied to the seal by quickly tracing the glass slide around the seal with tweezers. The hot plate was turned off, and the anode assembly was allowed to cool until the temperature was below 80° C.

### EQUIVALENTS AND SCOPE

In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

Furthermore, the invention encompasses all variations, combinations, and permutations in which one or more limitations, elements, clauses, and descriptive terms from one or more of the listed claims is introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group. It should it be understood that, in general, where the invention, or aspects of the invention, is/are referred to as comprising particular elements and/or features, certain embodiments of the invention or aspects of the invention consist, or consist essentially of, such elements and/or features. For purposes of simplicity, those embodiments have not been specifically set forth in haec verba herein. It is also noted that the terms “comprising” and “containing” are intended to be open and permits the inclusion of additional elements or steps. Where ranges are given, endpoints are included. Furthermore, unless otherwise indicated or otherwise evident from the context and understanding of one of ordinary skill in the art, values that are expressed as ranges can assume any specific value or sub-range within the stated ranges in different embodiments of the invention, to the tenth of the unit of the lower limit of the range, unless the context clearly dictates otherwise.

This application refers to various issued patents, published patent applications, journal articles, and other publications, all of which are incorporated herein by reference. If there is a conflict between any of the incorporated references and the instant specification, the specification shall control. In addition, any particular embodiment of the present invention that falls within the prior art may be explicitly excluded from any one or more of the claims. Because such embodiments are deemed to be known to one of ordinary skill in the art, they may be excluded even if the exclusion is not set forth explicitly herein. Any particular embodiment of the invention can be excluded from any claim, for any reason, whether or not related to the existence of prior art.

Those skilled in the art will recognize or be able to ascertain using no more than routine experimentation many equivalents to the specific embodiments described herein. The scope of the present embodiments described herein is not intended to be limited to the above Description, but rather is as set forth in the appended claims. Those of ordinary skill in the art will appreciate that various changes and modifications to this description may be made without departing from the spirit or scope of the present invention, as defined in the following claims.

1-53. (canceled)

54. An anode assembly for a battery cell, comprising:
a separator layer substantially free of pores;
an anode layer at least partially disposed on the separator layer and having a first surface facing the separator layer, a second surface facing away from the separator layer, and an outer surface extending from the first surface to the second surface, wherein the anode layer comprises a solid-state electrolyte (SSE) having pores;
an anode current collector coupled to the second surface of the anode layer; and
a seal at least partially disposed on the outer surface of the anode layer and comprising a sealant material, wherein the seal is substantially impervious to liquid.

55. The anode assembly of claim 54, wherein the separator layer comprises a SSE material, wherein the SSE material comprises a polymer, a sulfide, an oxide, a chalcogenide, or any combination thereof.

56. The anode assembly of claim 55, wherein the separator layer defines a recess, and wherein the seal is disposed in the recess of the separator layer.

57. The anode assembly of claim 56, wherein the separator layer has a thickness of from about 1 μm to about 300 μm.

58. The anode assembly of claim 57, further comprising an anode material disposed in at least a portion of the pores of the anode layer, wherein the anode material is selected from lithium metal, sodium metal, magnesium metal, or any combination thereof.

59. The anode assembly of claim 58, wherein the anode layer defines a first porous region between a center and the outer surface of the anode layer and a second porous region between the first porous region and the outer surface of the anode layer.

60. The anode assembly of claim 59, wherein the pores for the first porous region are substantially free of the sealant material.

61. The anode assembly of claim 60, wherein at least a portion of the pores of the second porous region comprise the sealant material.

62. The anode assembly of claim 61, wherein the seal is at least partially disposed on the outer surface of the anode layer and in the pores of the second porous region.

63. The anode assembly of claim 62, wherein the outer surface of the anode layer defines a recess, and wherein the seal is disposed in the recess of the anode layer.

64. The anode assembly of claim 63, wherein the anode layer has a thickness of from about 1 μm to about 500 μm.

65. The anode assembly of claim 54, wherein the anode current collector comprises a metal foil.

66. The anode assembly of claim 65, wherein the metal foil comprises copper, nickel, titanium, stainless steel, alloys thereof, or any combination thereof.

67. The anode assembly of claim 66, wherein the metal foil has a tab configured to connect with an external circuit.

68. The anode assembly of claim 67, wherein the seal is at least partially disposed on the separator layer.

69. The anode assembly of claim 68, wherein the seal is at least partially disposed on the anode current collector.

70. The anode assembly of claim 69, wherein the separator layer has a front surface facing the anode layer, a back surface facing away from the anode layer, and an outer surface extending from the front surface to the back surface, and wherein the anode current collector has an interior surface facing the anode layer, an exterior surface facing away from the anode layer, and an outer surface extending from the interior surface to the exterior surface.

71. The anode assembly of claim 70, wherein the seal is at least partially disposed on the outer surface of the separator layer.

72. The anode assembly of claim 71, wherein the seal is disposed on substantially all of the outer surface of the separator layer.

73. The anode assembly of claim 71, wherein the seal is at least partially disposed on the back surface of the separator layer.

74. The anode assembly of claim 71, wherein the seal is at least partially disposed on the front surface of the separator layer.

75. The anode assembly of claim 67, wherein the seal is at least partially disposed on the outer surface of the anode current collector.

76. The anode assembly of claim 75, wherein the seal is disposed on substantially all of the outer surface of the anode current collector.

77. The anode assembly of claim 67, wherein the seal is at least partially disposed on the interior surface of the anode current collector.

78. The anode assembly of claim 67, wherein the seal is at least partially disposed on each of the outer surface of the anode layer, the outer surface of the separator layer, and the outer surface of the anode current collector.

79. The anode assembly of claim 78, wherein the sealant material comprises a non-conductive polymer, a non-conductive glass, or any combination thereof.

80. The anode assembly of claim 79, wherein the sealant material comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof.

81. The anode assembly of claim 54, further comprising a housing having a plurality of interior walls defining an interior, wherein the separator layer, anode layer, anode current collector, and the seal are disposed in the interior of the housing.

82. The anode assembly of claim 81, wherein the seal extends from the outer surface of the anode layer to at least one of the plurality of interior walls of the housing.

83. The anode assembly of claim 82, wherein the housing further comprises a first protrusion and a second protrusion extending from at least one of the plurality of interior walls to the interior of the housing, wherein the first and second protrusions define a cavity, and wherein the seal extends from the outer surface of the anode layer into the cavity.

84. The anode assembly of claim 83, wherein at least a portion of the seal has a thickness of from about 1 μm to about 50 μm.

85. The anode assembly of claim 84, wherein the seal is pervious to gas.

86. A battery cell, comprising:
a separator layer substantially free of pores and having a front surface, a back surface spaced from the front surface, and an outer surface extending from the front surface to the back surface;
an anode layer at least partially disposed on the front surface of the separator layer and having a first surface facing the separator layer, a second surface facing away from the separator layer, and an outer surface extending from the first surface to the second surface, wherein the anode layer comprises a solid-state electrolyte (SSE) having pores;
an anode current collector coupled to the second surface of the anode layer;
a cathode layer at least partially disposed on the back surface of the separator layer and having a first surface facing the separator layer, a second surface facing away from the separator layer, and an outer surface extending from the first surface to the second surface;
a cathode current collector coupled to the second surface of the cathode layer; and
a seal at least partially disposed on the outer surface of the anode layer and comprising a sealant material, wherein the seal is substantially impervious to liquid.

87. The battery cell of claim 86, further comprising a housing having a plurality of interior walls defining an interior, wherein the separator layer, anode layer, anode current collector, cathode layer, cathode current collector, and the seal are disposed in the interior of the housing.

88. The battery cell of claim 87, wherein the anode current collector has an interior surface facing the anode layer, an exterior surface facing away from the anode layer, and an outer surface extending from the interior surface to the exterior surface, and wherein the cathode current collector has an interior surface facing the cathode layer, an exterior surface facing away from the cathode layer, and an outer surface extending from the interior surface to the exterior surface.

89. The battery cell of claim 88, wherein the seal is at least partially disposed on each of the outer surface of the anode layer, the outer surface of the separator layer, and the interior surfaces of the anode and cathode current collectors.

90. The battery cell of claim 89, wherein the cathode current collector defines an aperture configured to permit filling of the cathode layer with a catholyte.

91. The battery cell of claim 90, wherein the seal is at least partially disposed on each of the outer surface of the anode layer, the outer surface of the separator layer, the interior surface of the cathode current collector, and the outer and exterior surfaces of the anode current collector.

92. The battery cell of claim 90, further comprising a catholyte disposed in the cathode layer, wherein the seal is substantially impervious to the catholyte.

93. The battery cell of claim 92, wherein the sealant material comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof.

94. A method of forming an anode assembly, comprising:
(a) providing:
a separator layer substantially free of pores,
an anode layer at least partially disposed on the separator layer and having a first surface facing the separator layer, a second surface facing away from the separator layer, and an outer surface extending from the first surface to the second surface, wherein the anode layer comprises a solid-state electrolyte (SSE) having pores, and
an anode current collector coupled to the second surface of the anode layer; and
(b) forming a seal at least partially on the outer surface of the anode layer, wherein the seal is substantially impervious to liquid.

95. The method of claim 94, wherein the forming of step (b) comprises forming the seal from a sealant material by cold-pressing, hot-pressing, melting, 3D-printing, or any combination thereof, the sealant material at least partially on the outer surface of the anode layer.

96. The method of claim 95, wherein the sealant material is a polymer, and wherein the polymer comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof.

97. The method of claim 96, wherein forming of step (b) comprises forming the seal from a sealant material by applying the sealant material at least partially on the outer surface of the anode layer with a paintbrush, a roller, a plastic applicator, a metal applicator, a shaping tool, a syringe dispenser, a dispenser valve, or any combination thereof.

98. The method of claim 96, wherein the forming of step (b) comprises forming the seal from a sealant material by dip-coating at least a portion of the outer surface of the anode layer in the sealant material.
